(19) United States
(12) Patent Application Publication
(10) Pub. No.: US 2026/0261780 A1
(43) Pub. Date: Sep. 3, 2026

(54) IMAGING DEVICE

(71) Applicant: SONY SEMICONDUCTOR SOLUTIONS CORPORATION, KANAGAWA (JP)

(72) Inventors: IZUHO TANIHIRA, KANAGAWA (JP); YOUHEI OOSAKO, KANAGAWA (JP); SHINICHIROU ETOU, KANAGAWA (JP)

(21) Appl. No.: 19/490,006

(22) PCT Filed: Jun. 14, 2024
(86) PCT No.: PCT/JP2024/021623

§ 371 Date: Dec. 4, 2025

(30) Foreign Application Priority Data
Jun. 29, 2023 (JP) 2023-107483

(51) Int. Cl. H04N 25/772; H04N 25/76; H04N 25/771; H04N 25/78

(52) U.S. Cl. CPC H04N 25/772; H04N 25/771; H04N 25/7795; H04N 25/78

(57) ABSTRACT

By reducing the load of the signal wiring of a reference signal, it is possible to realize speeding up AD conversion, an increase in a frame rate, and a reduction in power consumption.

An imaging device includes: a plurality of photoelectric conversion elements arranged in a first direction and a second direction intersecting each other, each of the photoelectric conversion elements accumulating an electric charge corresponding to a light amount of incident light; a plurality of pixel circuits that outputs pixel signals corresponding to electric charges accumulated in the plurality of photoelectric conversion elements, respectively; a plurality of comparators that compares each of the plurality of pixel signals output from the plurality of pixel circuits with a reference signal; a digital signal generator that generates a digital signal obtained by analog-digital conversion of the plurality of pixel signals on the basis of comparison results of the plurality of comparators; and a plurality of switches that switches whether or not to input the reference signal to the plurality of comparators.

### TECHNICAL FIELD

The present disclosure relates to an imaging device.

### BACKGROUND ART

In an imaging device, it is common to provide a vertical signal line for each pixel column, transmit a pixel signal of each pixel in the pixel column to a column signal processing circuit by the vertical signal line, and perform signal processing such as analog-digital conversion (hereinafter, AD conversion).

However, when the number of pixels of the imaging device increases, the distance to the column signal processing circuit varies depending on the position of the pixel, and thus there is a problem in that a propagation delay of the pixel signal occurs on the vertical signal line and the signal level changes. In order to solve such a problem, a technique has been proposed in which the vertical signal line is divided into a plurality of lines, and the AD conversion is performed for each of the divided vertical signal lines (see Patent Document 1).

### CITATION LIST

### Patent Document

Patent Document 1: WO 2023/058720A1 specification

### SUMMARY OF THE INVENTION

### Problems to be Solved by the Invention

In order to perform AD conversion on a pixel signal, it is necessary to compare a reference signal, which is generally called a ramp signal, with the pixel signal. In Patent Document 1, an AD converter is separately provided for each of the plurality of divided vertical signal lines. For this reason, the reference signal needs to be distributed to a plurality of the AD converters, the load of the signal wiring for transmitting the reference signal increases, and it takes time to perform the AD conversion, which may be an obstacle to an increase in the frame rate and a reduction in power consumption.

Therefore, the present disclosure provides an imaging device capable of speeding up AD conversion, an increase in frame rate, and a reduction in power consumption by reducing the load on the signal wiring of the reference signal.

### Solutions to Problems

In order to solve the above problems, according to the present disclosure, provided is an imaging device including:
a plurality of photoelectric conversion elements arranged in a first direction and a second direction intersecting each other, each of the photoelectric conversion elements accumulating an electric charge corresponding to a light amount of incident light;
a plurality of pixel circuits that outputs pixel signals corresponding to electric charges accumulated in the plurality of photoelectric conversion elements, respectively;
a plurality of comparators that compares each of the plurality of pixel signals output from the plurality of pixel circuits with a reference signal;
a digital signal generator that generates a digital signal obtained by analog-digital conversion of the plurality of pixel signals on the basis of comparison results of the plurality of comparators; and
a plurality of switches that switches whether or not to input the reference signal to the plurality of comparators.

The plurality of switches may sequentially select any one of the plurality of comparators and input the reference signal so that the reference signal is not simultaneously input to two or more of the comparators.

A signal line that transmits the plurality of pixel signals output from two or more of the pixel circuits arranged in the second direction, and
a conversion circuit that performs analog-digital conversion of the plurality of pixel signals transmitted through the signal line may be further included, in which
the conversion circuit may include:
the comparator; and the digital signal generator.

A plurality of the signal lines arranged in the first direction, and
a plurality of the conversion circuits connected to the plurality of signal lines may be further included.

The signal line may include a plurality of divided signal lines divided along the second direction,
each of the plurality of divided signal lines may transmit the pixel signal output from two or more of the pixel circuits arranged along the second direction, and
each of the plurality of divided signal lines may be provided with one or more of the comparators.

Each of the plurality of comparators may be provided for a respective one of the plurality of pixel circuits.

The plurality of switches may switch whether or not to input the reference signal to the corresponding two or more comparators for each pixel group including two or more of the pixel circuits arranged in the first direction or the second direction.

The plurality of switches may sequentially switch and select, among a plurality of pixel groups each including two or more of the pixel circuits arranged in the first direction or the second direction, any one of a plurality of the pixel groups corresponding to a focused pixel region.

The plurality of switches may sequentially switch and select, among a plurality of pixel groups each including two or more of the pixel circuits arranged in the first direction or the second direction, any one of two or more pixel groups adjacent in the first direction or the second direction.

The digital signal generator may include a counter that outputs, as the digital signal, a count value corresponding to a timing at which the pixel signal and the reference signal match in each of the plurality of comparators.

At least one of the plurality of switches may include:
a first transistor of a first conductivity type that switches whether to conduct or cut off a first node and a second node by a switching control signal; and
a second transistor of a second conductivity type that switches whether to conduct or cut off the first node and the second node by an inversion switching control signal having a logic opposite to that of the switching control signal.

At least one of the plurality of switches may include:
a third transistor of a first conductivity type having a source and a drain connected to the first node, and a gate to which the inversion switching control signal is input;
a fourth transistor of a first conductivity type having a source and a drain connected to the second node, and a gate to which the inversion switching control signal is input;
a fifth transistor of a second conductivity type having a source and a drain connected to the first node, and a gate to which the switching control signal is input; and
a sixth transistor of a second conductivity type having a source and a drain connected to the second node, and a gate to which the switching control signal is input.

A capacitor arranged between the second node and a reference voltage node may be further included, in which
the second node may be connected to input nodes of the plurality of comparators.

At least one of the plurality of switches may include:
a first transistor that switches whether to conduct or cut off the first node and the second node by a switching control signal;
a voltage source that outputs a bias voltage between a third node and a fourth node;
a first switch, a second switch, and a third switch connected in series between the third node and a reference voltage node;
a fourth switch and a fifth switch connected in series between the fourth node and the first node;
a first capacitor connected between a connection node of the first switch and the second switch and a connection node of the fourth switch and the fifth switch; and
a second capacitor connected between the second node and the reference voltage node,
the switching control signal output from a connection node of the second switch and the third switch may be input to a gate of the first transistor,
when the first node and the second node are brought into conduction, the first switch, the third switch, and the fourth switch may be cut off, and the second switch and the fifth switch may be conducted, and
when the first node and the second node are cut off, the first switch, the third switch, and the fourth switch may be conducted, and the second switch and the fifth switch may be cut off.

At least one of the plurality of switches may include:
a first transistor that switches whether to conduct or cut off the first node and the second node by a switching control signal;
a first switch, a second switch, and a third switch connected in series between a first reference voltage node and a second reference voltage node;
a fourth switch and a fifth switch connected in series between the second reference voltage node and the first node;
a first capacitor connected between a connection node of the first switch and the second switch and a connection node of the fourth switch and the fifth switch; and
a second capacitor connected between the second node and the second reference voltage node,
the switching control signal output from a connection node of the second switch and the third switch may be input to a gate of the first transistor,
when the first node and the second node are brought into conduction, the first switch, the third switch, and the fourth switch may be cut off, and the second switch and the fifth switch may be conducted, and
when the first node and the second node are cut off, the first switch, the third switch, and the fourth switch may be conducted, and the second switch and the fifth switch may be cut off.

A plurality of preamplifiers arranged between the plurality of switches and the plurality of comparators and including a plurality of source follower circuits that converts impedances of the reference signals output from the plurality of switches may be further included, in which
each of the plurality of source follower circuits may include:
a first transistor having a gate to which the reference signal output from the corresponding switch is input;
a second transistor of a first conductivity type that is connected to a drain side of the first transistor and is turned on when the corresponding switch outputs the reference signal and is turned off when the corresponding switch does not output the reference signal; and
a third transistor of a second conductivity type that is connected to a source side of the first transistor and is turned on when the corresponding switch outputs the reference signal and is turned off when the corresponding switch does not output the reference signal.

Each of the plurality of source follower circuits may include:
a fourth transistor that functions as a current source; and
a fifth transistor that adjusts a voltage of an input node of the corresponding comparator,
between a first reference voltage node and a second reference voltage node, the fourth transistor, the third transistor, the fifth transistor, the first transistor, and the second transistor may be connected in this order, or the fourth transistor, the fifth transistor, the third transistor, the first transistor, and the second transistor may be connected in this order.

A plurality of preamplifiers arranged between the plurality of switches and the plurality of comparators and including a plurality of source follower circuits that convert impedances of the reference signals output from the plurality of switches may be further included, in which
each of the plurality of source follower circuits may include:
a first transistor having a gate to which the reference signal output from the corresponding switch is input;
a second transistor of a first conductivity type that is connected to a drain side of the first transistor and is turned on when the corresponding switch outputs the reference signal and is turned off when the corresponding switch does not output the reference signal;
a third transistor that is connected to a source side of the first transistor and functions as a current source;
a fourth transistor that adjusts a voltage of an input node of the corresponding comparator;
a fifth transistor that is connected to a gate of the fourth transistor and is turned on when the corresponding switch outputs the reference signal to turn on the fourth transistor; and
a sixth transistor that is connected to a gate of the fourth transistor and turns on when the corresponding switch does not output the reference signal to turn off the fourth transistor.

A precharge circuit that supplies a precharge signal to a source of the first transistor in a source follower circuit that does not output the reference signal from a source of the first transistor among the plurality of source follower circuits may be further included.

The precharge circuit may further include a replica circuit that has the same circuit configuration as the plurality of source follower circuits and generates, as the precharge signal, a reference voltage of the reference signal when the plurality of comparators starts a comparison operation, and
the precharge circuit may supply the reference voltage generated by the replica circuit to a source of the first transistor in a source follower circuit that does not input the reference signal to the corresponding comparator among the plurality of source follower circuits.

### BRIEF DESCRIPTION OF DRAWINGS

FIG. 1 is a block diagram illustrating a configuration of an example of an electronic device commonly applicable to each embodiment.

FIG. 2 is a block diagram illustrating a configuration of an example of an imaging device in each embodiment of the present disclosure.

FIG. 3 is a schematic diagram schematically illustrating signal processing on a pixel signal by existing technology.

FIG. 4A is a diagram illustrating an example in which the imaging device according to the present disclosure is formed using a stacked CIS having a two-layer structure.

FIG. 4B is a diagram illustrating an example in which the imaging device according to the present disclosure is formed using a stacked CIS having a three-layer structure.

FIG. 5 is a schematic diagram illustrating a structure of an example of the imaging device.

FIG. 6 is a schematic diagram schematically illustrating signal processing on a pixel signal according to the present disclosure.

FIG. 7 is a schematic diagram illustrating an example in which a pixel array section is divided into a plurality of regions in a vertical direction.

FIG. 8 is a schematic diagram schematically illustrating signal processing on the pixel signal according to the imaging device according to the present disclosure.

FIG. 9 is a schematic diagram for explaining division of a VSL according to the imaging device according to the present disclosure.

FIG. 10A is a view for selecting the uppermost column readout section among four column readout sections.

FIG. 10B is a view for selecting the second column readout section from the top among four column readout sections.

FIG. 11 is a graph illustrating a relationship between the number of reference signal switches that are simultaneously turned on and a load of a reference signal line.

FIGS. 12A and 12B are graphs illustrating a relationship between a settling time and a signal band of a reference signal on a reference signal line.

FIG. 13 is a timing diagram of the imaging device according to a first embodiment.

FIG. 14 is a circuit diagram illustrating a first example of the reference signal switch.

FIG. 15 is a circuit diagram illustrating a second example of the reference signal switch.

FIG. 16 is a circuit diagram illustrating a third example of the reference signal switch.

FIG. 17 is a circuit diagram illustrating a fourth example of the reference signal switch.

FIG. 18 is a circuit diagram illustrating a fifth example of the reference signal switch.

FIG. 19A is a block diagram around a column readout section of the imaging device according to a second embodiment.

FIG. 19B is a block diagram around the column readout section of the imaging device according to the second embodiment.

FIG. 20 is a circuit diagram illustrating a first example of an internal configuration of a preamplifier.

FIG. 21 is a circuit diagram illustrating a second example of the internal configuration of the preamplifier.

FIG. 22 is a circuit diagram illustrating a third example of the internal configuration of the preamplifier.

FIG. 23 is a circuit diagram illustrating a fourth example of the internal configuration of the preamplifier.

FIG. 24 is a graph illustrating settling time of a reference signal input to the column readout section in a case where the output node of a source follower circuit is precharged and in a case where the output node is not precharged.

FIG. 25 is a circuit diagram around the column readout section 17 of the imaging device according to a third embodiment.

FIG. 26A is a view for explaining a precharge operation of the imaging device according to the third embodiment.

FIG. 26B is a view for explaining a precharge operation of the imaging device according to the third embodiment.

FIG. 27 is a timing diagram corresponding to the explanation of FIGS. 26A and 26B.

FIG. 28 is a block diagram of the imaging device according to a fourth embodiment.

FIG. 29 is a diagram illustrating an example of arrangement places of two column readout sections in FIG. 28.

FIG. 30 is a block diagram of the imaging device according to a modification of the fourth embodiment.

FIG. 31 is a view illustrating arrangement places of two column readout sections in FIG. 30.

FIG. 32 is a timing diagram of the imaging device according to the fourth embodiment.

FIG. 33 is a timing diagram of the imaging device according to the modification of the fourth embodiment.

FIG. 34 is a diagram for explaining the imaging device according to a fifth embodiment.

FIG. 35 is a diagram for explaining the imaging device according to a modification of the fifth embodiment.

FIG. 36 is a diagram for explaining the imaging device according to a sixth embodiment.

FIG. 37 is a block diagram illustrating an example of a schematic configuration of a vehicle control system.

FIG. 38 is an explanatory diagram illustrating an example of installation positions of an outside-vehicle information detecting section and an imaging section.

### MODE FOR CARRYING OUT THE INVENTION

Hereinafter, embodiments of an imaging device will be described with reference to the drawings. Although main components of the imaging device will be mainly described below, the imaging device may have components and functions that are not illustrated or described. The following description does not exclude the components and functions that are not illustrated or described.

### (Electronic Device Commonly Applicable to Each Embodiment)

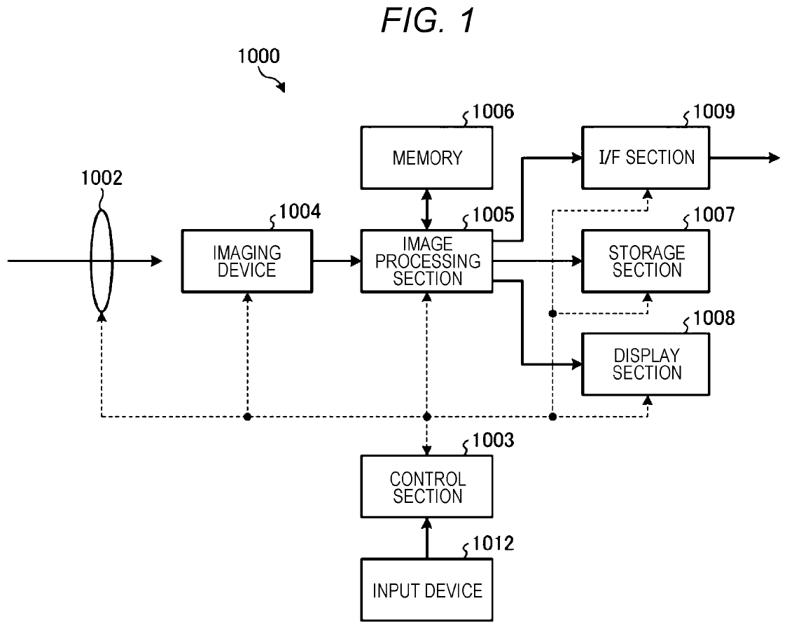

FIG. 1 is a block diagram illustrating a configuration of an example of an electronic device commonly applicable to each embodiment. In FIG. 1, an electronic device 1000 includes an optical system 1002, a control section 1003, an imaging device 1004, an image processing section 1005, a memory 1006, a storage section 1007, a display section 1008, an interface (I/F) section 1009, and an input device 1012. Here, examples of the electronic device 1000 include a digital still camera, a digital video camera, and a mobile phone, a smartphone, or the like with an imaging function. Furthermore, a surveillance camera, an in-vehicle camera, a medical camera, or the like can also be applied as the electronic device 1000.

The imaging device 1004 includes, for example, a plurality of photoelectric conversion elements arranged in a matrix array. The photoelectric conversion element converts received light into electric charge through photoelectric conversion. The imaging device 1004 includes a drive circuit that drives the plurality of photoelectric conversion elements, a signal processing circuit that reads out electric charges from each of the plurality of photoelectric conversion elements and generates image data on the basis of the read-out electric charges, and a power supply circuit that supplies power to the drive circuit.

The optical system 1002 includes a main lens including one or a combination of a plurality of lenses, and a mechanism for driving the main lens, and forms an image of subject light (incident light) from a subject on a light receiving surface of the imaging device 1004 through the main lens. Furthermore, the optical system 1002 includes an autofocus mechanism that adjusts focus in accordance with a control signal, and a zoom mechanism that changes a zoom ratio in accordance with the control signal. Furthermore, the electronic device 1000 may allow the optical system 1002 to be attachable and detachable so that the optical system 1002 can be replaced with another optical system 1002.

The image processing section 1005 executes predetermined image processing on the pixel data output from the imaging device 1004. For example, the image processing section 1005 is connected to the memory 1006 such as a frame memory, and writes the image data output from the imaging device 1004, to the memory 1006. The image processing section 1005 executes predetermined image processing on the pixel data written in the memory 1006, and writes the pixel data subjected to the image processing to the memory 1006 again. Note that the memory 1006 can store one frame of pixel data as image data.

The storage section 1007 is, for example, a non-volatile memory such as a flash memory or a hard disk drive, and stores the image data output from the image processing section 1005 in a non-volatile manner. The display section 1008 includes, for example, a display device such as a liquid crystal display (LCD) and a drive circuit that drives the display device, and can display an image based on the image data output from the image processing section 1005. The I/F section 1009 is an interface for transmitting the image data output from the image processing section 1005, to the outside. For example, a universal serial bus (USB) can be applied as the I/F section 1009. The present invention is not limited thereto, and the I/F section 1009 may be an interface connectable to a network through wired communication or wireless communication.

The input device 1012 includes an operation element or the like for receiving a user's input. In a case where the electronic device 1000 is, for example, a digital still camera, a digital video camera, or a mobile phone or smartphone with an imaging function, the input device 1012 may include a shutter button for instructing the imaging by the imaging device 1004, or an operation element for implementing the function of the shutter button.

The control section 1003 includes, for example, a processor such as a central processing unit (CPU), a read only memory (ROM), and a random access memory (RAM), and controls the entire operation of the electronic device 1000 by using the RAM as a work memory in accordance with a program stored in the ROM in advance. For example, the control section 1003 can control the operation of the electronic device 1000 according to the user's input received through the input device 1012. Furthermore, the control section 1003 can control the autofocus mechanism in the optical system 1002 on the basis of an image processing result of the image processing section 1005.

### First Embodiment

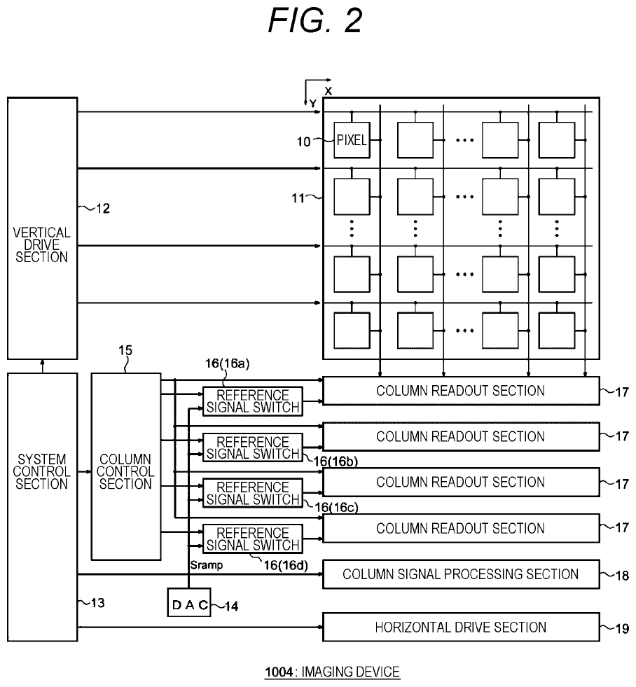

FIG. 2 is a block diagram of the imaging device 1004 according to the first embodiment of the present disclosure. In FIG. 2, the imaging device 1004 includes a pixel array section 11, a vertical drive section 12, a system control section 13, a digital to analog converter (DAC) 14, a column control section 15, a plurality of reference signal switches (switches) 16, a plurality of column readout sections 17, a column signal processing section 18, and a horizontal drive section 19. The imaging device 1004 can be configured as a complementary metal oxide semiconductor (CMOS) image sensor (CIS) in which these components are integrally formed using the CMOS.

The pixel array section 11 includes a plurality of pixels 10 arranged in a first direction (for example, in the horizontal direction or the row direction) X, and a second direction (for example, in the vertical direction or the column direction) Y.

In the pixel array section 11, each pixel 10 includes a photoelectric conversion element that generates an electric charge in response to received light, and a pixel circuit that outputs a pixel signal on the basis of the electric charge generated by the photoelectric conversion element. The vertical drive section 12 drives each pixel 10 included in the pixel array section 11 for each row and causes each pixel 10 to output a pixel signal. At this time, the vertical drive section 12 sequentially drives each pixel 10 according to the order of rows and causes each pixel 10 to output the pixel signal. That is, the vertical drive section 12 functions as a readout control circuit that controls the reading out of the electric charge from the photoelectric conversion element and the output of the pixel signals.

The system control section 13 controls each operation timing of the vertical drive section 12, the DAC 14, the column control section 15, the plurality of column readout sections 17, the column signal processing section 18, and the horizontal drive section 19 in synchronization with a vertical synchronization signal VSYNC. The vertical synchronization signal VSYNC is a periodic signal having a predetermined frequency (for example, 60 hertz (Hz)) that indicates the imaging timing.

The DAC 14 generates a predetermined reference signal by digital to analog (DA) conversion. As the reference signal, for example, a sawtooth-shaped reference (RAMP) signal is used. The DAC 14 supplies the reference signal to the column signal processing section 18.

In the imaging device 1004 according to the first embodiment, each of a plurality of vertical signal lines VSL extending in the second direction (column direction) Y of the pixel array section 11 is divided into a plurality of signal lines, and a plurality of column control sections 15 is provided corresponding to the plurality of divided signal lines.

The plurality of column control sections 15 performs switching control of the plurality of reference signal switches 16 in accordance with an instruction from the system control section 13. The plurality of reference signal switches 16 switches whether or not to input the reference signal generated by the DAC 14 to the plurality of column readout sections 17.

Each of the plurality of column readout sections 17 includes a plurality of analog-digital converters (hereinafter, an ADC), and each ADC converts a pixel signal into a digital signal. As described later, the ADC includes a comparator (also referred to as a comparator) 20 and a counter 30 (a digital signal generator). The plurality of reference signal switches 16 described above is provided corresponding to the plurality of column readout sections 17. The plurality of reference signal switches 16 sequentially selects any one of the plurality of column readout sections 17 and inputs the reference signal such that the reference signal is not simultaneously input to two or more column readout sections 17.

The column signal processing section 18 performs, for each column, signal processing such as correlated double sampling (CDS) processing on the digital signals of the pixel signals AD-converted by the plurality of column readout sections 17. The column signal processing section 18 outputs the digital pixel signals (pixel data) after the signal processing. The pixel data output from the column signal processing section 18 is supplied to the image processing section 1005.

The horizontal drive section 19 includes a shift register, an address decoder, and the like, and causes the column signal processing section 18 to sequentially output pixel data subjected to signal processing for each column by the column signal processing section 18.

### (Flow of Processing by Existing Technology)

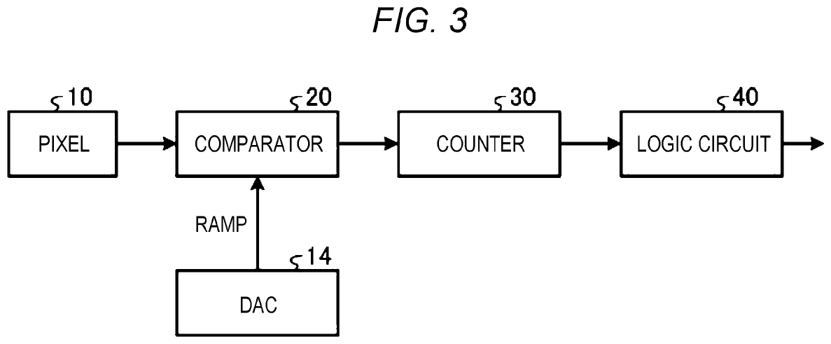

Next, signal processing on the pixel signal according to the existing technology will be schematically described. FIG. 3 is a schematic diagram schematically illustrating the signal processing on the pixel signal according to the existing technology. In FIG. 3, the comparator 20 and the counter 30 are included, for example, in the column readout section 17 in FIG. 2, and a logic circuit is included, for example, in the column signal processing section 18 in FIG. 2.

The analog pixel signal output from the pixel 10 is supplied to the comparator 20. Moreover, a reference signal RAMP as a reference signal is supplied from the DAC 14 to the comparator 20. The reference signal RAMP is, for example, a signal in which a level (voltage value) is gradually decreased over time, for example, in accordance with predetermined clock pulses. The comparator 20 compares the pixel signal with the reference signal RAMP, and supplies a comparison result to the counter 30. For example, in a case where the level of the reference signal RAMP is higher than the level of the pixel signal, the comparator 20 outputs a high-level difference signal to the counter 30. On the other hand, in a case where the level of the reference signal RAMP becomes the same as or equal to or lower than the level of the pixel signal, the comparator 20 inverts the output and outputs a low-level difference signal to the counter 30.

The counter 30 counts, during each of a preset phase (P phase) period and a data phase (D phase) period, the time from when the reference signal RAMP starts to drop in voltage until the level of the reference signal RAMP becomes the same as or equal to or lower than the level of the pixel signal, in accordance with the difference signal input from the comparator 20, and outputs the respective count results to the logic circuit 40. Note that the P phase period is a period for detecting the reset level of the pixel signal in the CDS processing, and the D phase period is a detection period for detecting the signal level of the pixel signal in the CDS processing.

The logic circuit 40 performs the CDS processing and the AD conversion processing on the basis of the count result of the P phase period and the count result of the D phase period that are input from the counter 30, and generates and outputs the digital pixel signal (pixel data).

### (Structure of Imaging Device 1004 Applicable to Each Embodiment)

Next, the structure of the imaging device 1004 applicable to each embodiment will be schematically described. The imaging device 1004 according to the embodiment can be formed with a stacked structure in which a plurality of layers of semiconductor chips is stacked.

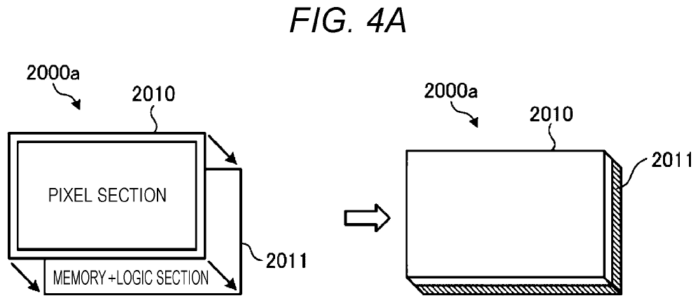

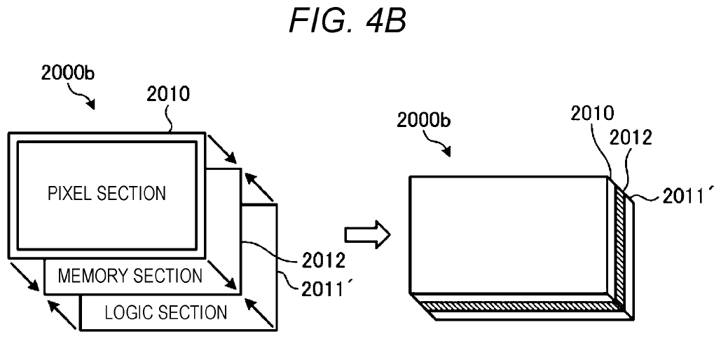

As an example, the imaging device 1004 can be formed with a two-layer structure in which semiconductor chips are stacked in two layers. FIG. 4A is a diagram illustrating an example in which the imaging device 1004 according to each embodiment is formed using a stacked CIS having a two-layer structure. In the structure of FIG. 4A, a pixel section 2010 is formed on the first-layer semiconductor chip, and a memory+logic section 2011 is formed on the second-layer semiconductor chip.

The pixel section 2010 includes at least the pixel array section 11. The memory+logic section 2011 may include, for example, the vertical drive section 12, the system control section 13, the DAC 14, the column signal processing section 18, the horizontal drive section 19, and an interface for performing communication between the imaging device 1004 and an external device. Furthermore, the memory+logic section 2011 may also include, for example, a memory for storing pixel data output from the column signal processing section 18.

As illustrated on the right side of FIG. 4A, the imaging device 1004 is configured as one solid-state imaging element 2000a by bonding the first-layer semiconductor chip and the second-layer semiconductor chip while electrically contacting each other.

As another example, the imaging device 1004 can be formed with a three-layer structure in which semiconductor chips are stacked in three layers. FIG. 4B is a diagram illustrating an example in which the imaging device 1004 according to each embodiment is formed using a stacked CIS having a three-layer structure. In the structure of FIG. 4B, the pixel section 2010 is formed on the first-layer semiconductor chip, a memory section 2012 is formed on the second-layer semiconductor chip, and a logic section 2011′ is formed on the third-layer semiconductor chip. In this case, the logic section 2011′ may include the vertical drive section 12, the system control section 13, the DAC 14, the column signal processing section 18, the horizontal drive section 19, and an interface for performing communication between the imaging device 1004 and an external device. Furthermore, the memory section 2012 may also include, for example, a memory for storing pixel data output from the column signal processing section 18.

As illustrated on the right side of FIG. 4B, the imaging device 1004 is configured as one solid-state imaging element 2000b by bonding the first-layer semiconductor chip, the second-layer semiconductor chip, and the third-layer semiconductor chip while electrically contacting each other.

### (Stacked Structure)

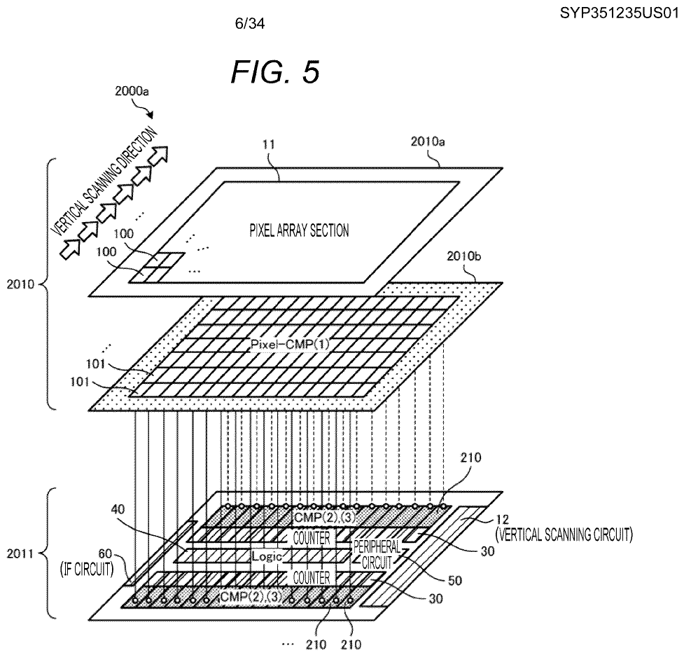

As illustrated in FIGS. 4A and 4B, the imaging device 1004 according to the first embodiment can be configured by stacking a plurality of semiconductor substrates. The number of stacked layers is optional. FIG. 5 is a schematic diagram illustrating a stacked structure of the imaging device 1004 according to the first embodiment. In the example of FIG. 5, the imaging device 1004 applies the solid-state imaging element 2000a having the two-layer structure, described with reference to FIG. 4A. Here, in the case of a back-illuminated image sensor, the photoelectric conversion elements are formed on a first layer 2010a of the substrate, and the pixel circuits that convert the electric charge generated by the photoelectric conversion elements into pixel signals and output the pixel signals are formed on a second layer 2010b of the substrate. The first layer 2010a and the second layer 2010b constitute the pixel section 2010.

In FIG. 5, photoelectric conversion sections 100, each of which includes a photoelectric conversion element and a transistor for controlling the readout of the electric charge from the photoelectric conversion element, are arranged in a matrix array on the first layer 2010a. Circuit sections 101, each of which includes a pixel circuit that converts the electric charge read out from the photoelectric conversion section 100 into the pixel signal, are arranged in a matrix array on the second layer 2010b to correspond to the photoelectric conversion sections 100 on the first layer 2010a. More specifically, the circuit section 101 is arranged in a one-to-one relationship with the photoelectric conversion section 100 located in the corresponding position on the first layer 2010a, while being in electrical contact between the first layer 2010a and the second layer 2010b.

In each embodiment, moreover, the circuit section 101 (denoted as Pixel-CMP (1) in the drawing) includes a part of the comparator 20. That is, in each embodiment, the comparator 20 is configured by being divided into at least two parts of a first circuit (denoted as CMP (1)) to which the pixel signal is directly supplied from the pixel circuit, and second and third circuits (denoted as CMP (2), (3)) to which the output of the first circuit is supplied. The first circuit includes, for example, a circuit that compares the pixel signal output from the pixel circuit with the reference signal RAMP supplied from the DAC 14.

In FIG. 5, the vertical drive section 12, the counter 30, the logic circuit 40, a peripheral circuit 50, and an interface circuit 60 (also referred to as an IF circuit in the drawing) are arranged in the memory+logic section 2011.

The peripheral circuit 50 includes the DAC 14. Furthermore, the interface circuit 60 is an interface for transmitting and receiving signals between the imaging device 1004 as the solid-state imaging element 2000a and the outside.

In the example of FIG. 5, the vertical drive section 12 is arranged along the column direction of the pixel array section 11 at one end (the right end in the example of the drawing) in the row direction of the memory+logic section 2011. Furthermore, the interface circuit 60 is arranged along the column direction of the pixel array section 11 at the other end (the left end in the example of the drawing) in the row direction of the memory+logic section 2011.

Furthermore, a second circuit 210 obtained by dividing the comparator 20 is arranged in the memory+logic section 2011. In the example of FIG. 5, the second circuit 210 is arranged along the row direction of the memory+logic section 2011 at one end and the other end (the upper and lower ends in the example of FIG. 5) in the column direction. The second circuit 210 is provided for each column in the pixel array section 11. In the example of FIG. 5, the second circuit 210 is provided along the row direction of the pixel array section 11 at both ends in the column direction of the memory+logic section 2011.

The second circuit 210 is shared by a plurality of the circuit sections 101 arranged along the columns in the second layer 2010b. For example, each second circuit 210 arranged at one end (for example, the upper end in the drawing) in the column direction of the memory+logic section 2011 is shared, for each column, by the circuit sections 101 arranged on the one-end-side half (the upper-side half in the example of FIG. 5) among the circuit sections 101 arranged in the second layer 2010b. Similarly, each second circuit 210 arranged at the other end (for example, the lower end in FIG. 5) in the column direction of the memory+logic section 2011 is shared, for each column, by the circuit sections 101 arranged on the other-end-side half (the lower-side half in the example of FIG. 5) among the circuit sections 101 arranged in the second layer 2010b.

Note that each pixel 10 (each photoelectric conversion section 100 and each circuit section 101) is scanned in the column direction, that is, in the vertical direction, as indicated by the arrows. The output from each pixel 10 (each circuit section 101) is transferred to the memory+logic section 2011 for each row.

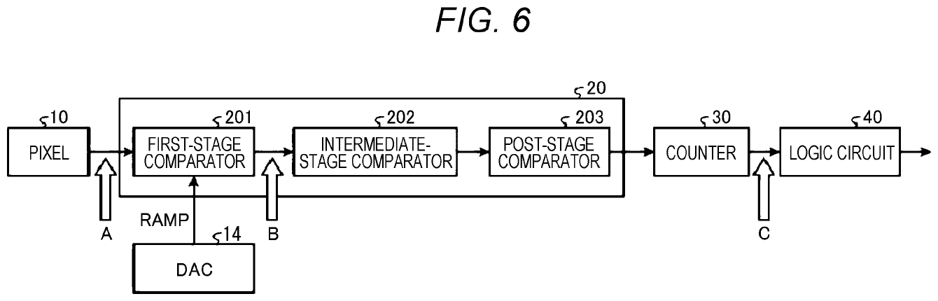

FIG. 6 is a schematic diagram schematically illustrating signal processing on the pixel signal according to the present disclosure. The comparator 20 according to the present disclosure can be configured by being divided into a plurality of circuits. In the example of FIG. 6, the comparator 20 is divided into three circuits of a first-stage comparator 201, an intermediate-stage comparator 202, and a post-stage comparator 203. The first-stage comparator 201 corresponds to the first circuit described with reference to FIG. 5, and includes, for example, a circuit that compares the pixel signal output from the pixel 10 with the reference signal RAMP supplied from the DAC 14. The intermediate-stage comparator 202 and the post-stage comparator 203 correspond to the second circuit described with reference to FIG. 5, and compare the output of the first circuit with a threshold value. The intermediate-stage comparator 202 and the post-stage comparator 203 can also be configured as a single circuit.

(Example of Dividing Pixel Array Section 11 into Regions)

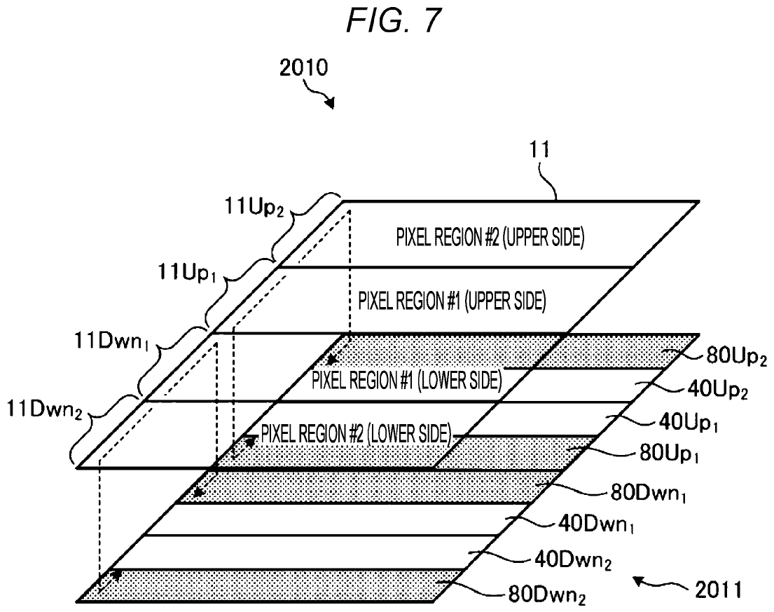

By dividing the pixel array section 11 into a plurality of regions in the vertical direction and transferring the pixel signal for each divided region, it is possible to shorten the transmission distance of the pixel signal. FIG. 7 is a schematic diagram illustrating an example in which the pixel array section 11 is divided into a plurality of regions in the vertical direction.

In the example of FIG. 7, in the pixel section 2010, the pixel array section 11 is divided in the vertical direction into four regions of pixel regions 11Up₁ and 11Up₂, and pixel regions 11Dwn₁ and 11Dwn₂. Among the pixel regions, the pixel regions 11Up₁ and 11Up₂ are respectively first and second pixel regions on the upper side, and the pixel regions 11Dwn₁ and 11Dwn₂ are respectively first and second pixel regions on the lower side.

In the memory+logic section 2011, an analog circuit 80Up₁ and a logic circuit 40Up₁ are arranged at positions corresponding to the pixel region 11Up₁, and an analog circuit 80Up₂ and a logic circuit 40Up₂ are arranged at positions corresponding to the pixel region 11Up₂. Similarly, an analog circuit 80Dwn₁ and a logic circuit 40Dwn₁ are arranged at positions corresponding to the pixel region 11Dwn₁, and an analog circuit 80Up₂ and a logic circuit 40Dwn₂ are arranged at positions corresponding to the pixel region 11Up₂.

Note that each of the analog circuits 80Up₁, 80Up₂, 80Dwn₁, and 80Dwn₂ includes, for example, the pixel circuit, the comparator 20, and the counter 30.

The pixel signal output from each pixel in the pixel region 11Up₁ is transferred, for each row, through the vertical signal line VSL within the pixel region 11Up₁, from the end portion of the pixel region 11Up₁ to the memory+logic section 2011, and is input to the analog circuit 80Up₁. The output of the analog circuit 80Up₁ is input to the logic circuit 40Up₁. The similar processing applies to the pixel regions 11Up₂, 11Dwn₁, and 11Dwn₂.

With the configuration of FIG. 7, the pixel signal output from each pixel is transferred over a distance of at most one-fourth the distance between both ends in the column direction of the pixel array section 11. However, the fact that the pixel signal is transmitted through the vertical signal line VSL is not changed from the existing configuration. Therefore, the parasitic capacitance of the shortened vertical signal line VSL affects only the settling in each pixel 10 and is unlikely to lead to improvements in characteristics such as the influence of noise.

On the other hand, in each embodiment of the present disclosure, since the distance over which the pixel signal corresponding to the electric charge generated in the pixel 10 is transmitted to the first-stage comparator 201 is made extremely short, the settling time in the pixel 10 can be shortened, and with this arrangement, the readout time of the electric charge from the pixel 10 can be sped up. Furthermore, since the vertical signal line VSL, which is a large load, is connected to the output side of the first-stage comparator 201, the bandwidth of the signal transferred to the vertical signal line VSL can be narrowed, and noise can be reduced.

In the above description, the vertical signal line VSL is divided in the vertical direction to reduce the load on the vertical signal line VSL. However, even in a case where the number of divisions of the vertical signal line VSL is increased, routing wiring to the input terminal of the ADC provided in the column signal processing section 18 is required, and thus it is difficult to speed up the processing and increase a frame rate. For example, in a two-layer stacked structure, the number of divisions of the vertical signal line VSL is limited to about two. Furthermore, since one ADC corresponds to a plurality of pixels, the load at a pixel switching portion becomes heavy.

Therefore, in the imaging device 1004 according to the present disclosure, one first-stage comparator 201 is arranged for each divided region of the vertical signal line VSL in the intermediate layer (the second layer of the first substrate) in the three-layer configuration including the first layer and second layer of the first substrate and the second substrate, and the output of the first-stage comparator 201 is switched by a select switch and input to the intermediate-stage comparator 202. By adopting such a configuration, the VSL load is reduced by the increase in the number of divisions of the vertical signal line VSL, and it is possible to speed up the processing and increase a frame rate.

Furthermore, in the imaging device 1004 according to the present disclosure, a plurality of pixels (photoelectric conversion sections 100) is connected to one first-stage comparator 201. That is, the imaging device 1004 according to the present disclosure is configured to switch connections at two points: between the pixel and the first-stage comparator 201, and between the first-stage comparator 201 and the intermediate-stage comparator 202. As a result, the load at the pixel switching portion (that is, the VSL wiring) can be reduced.

FIG. 8 is a schematic diagram schematically illustrating signal processing on the pixel signal according to the imaging device 1004 according to the present disclosure.

Similar to FIG. 6 described above, in FIG. 8, the comparator 20 includes the first-stage comparator 201, the intermediate-stage comparator 202, and the post-stage comparator 203, and the output of the post-stage comparator 203 is input to the counter 30, and the output of the counter 30 is input to the logic circuit 40. Furthermore, the reference signal RAMP output from the DAC 14 is supplied to the first-stage comparator 201.

In the configuration illustrated in FIG. 8, pixel signals from N (N≥1) pixels 10₁, 10₂, . . . , and 10_{N} are input to the first-stage comparator 201. The outputs of M (M≥2) pixel/first-stage comparator sections 250₁, 250₂, . . . , and 250_{M} each including the first-stage comparator 201 and the pixels 10₁, 10₂, . . . , and 10_{N} are input to the intermediate-stage comparator 202.

Furthermore, among these, each of the pixels 10₁, 10₂, . . . , 10_{N} included in each of the pixel/first-stage comparator sections 250₁, 250₂, . . . , 250_{M} is arranged on the first layer 2010a of the pixel section 2010, and each of the first-stage comparators 201 is arranged on the second layer 2010b of the pixel section 2010. The configurations after the intermediate-stage comparator 202 onward are arranged in the memory+logic section 2011.

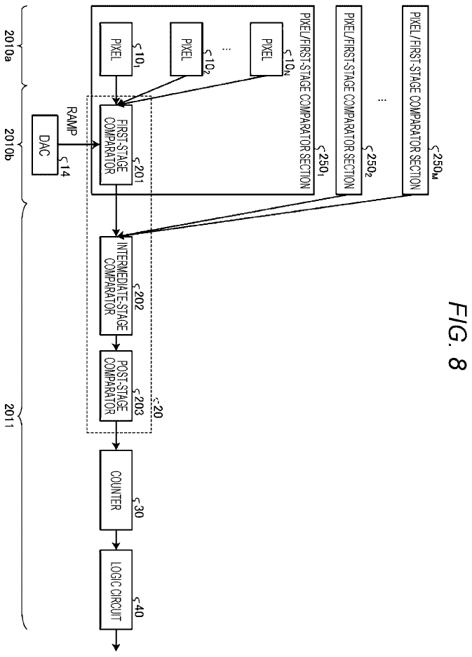

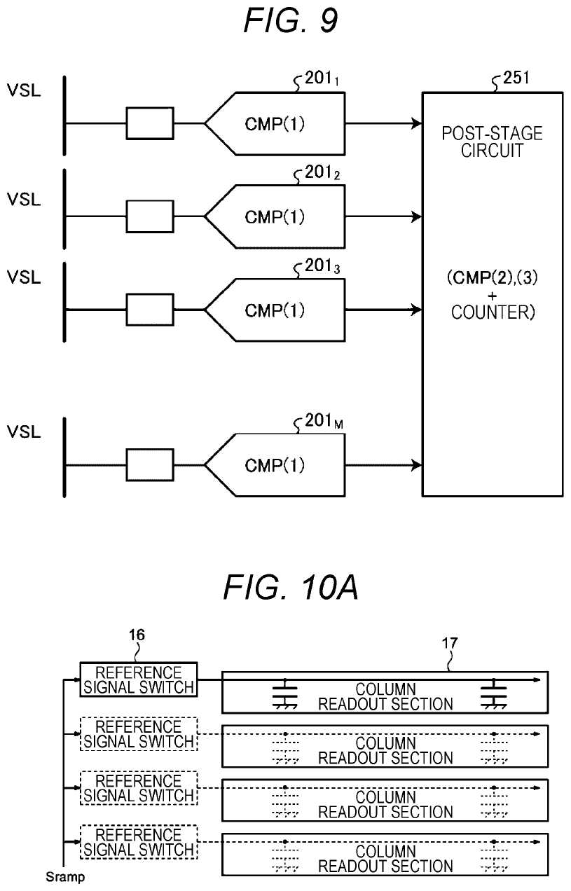

FIG. 9 is a schematic diagram for explaining the division of the VSL according to the imaging device 1004 according to the present disclosure. Note that, in FIG. 9, first-stage comparators 201₁ to 201_{M} are each also illustrated as the first circuit CMP (1). Furthermore, a post-stage circuit 251 includes the intermediate-stage comparator 202, the post-stage comparator 203 (second circuit and third circuit CMP (2), (3)), and the counter 30.

As illustrated in FIG. 9, the VSL connects each of the pixels 10₁ to 10_{N} with the corresponding first-stage comparators 201₁ to 201_{M} in each of the pixel/first-stage comparator sections 250₁, 250₂, . . . , and 250_{M}. That is, in the imaging device 1004 according to the present disclosure, the VSL is divided for each first-stage comparator 201₁ to 201_{M}.

As described above, in the imaging device 1004 according to the present disclosure, the signal paths are switched between each of the pixels 10₁ to 10_{N} and the first-stage comparator 201, and between each of the pixel/first-stage comparator sections 250₁ to 250_{M}. Therefore, the VSL is divided for each of the first-stage comparators 201₁ to 201_{M}, and the load on the VSL wiring is reduced.

### Detailed Description of First Embodiment

As illustrated in FIG. 2, the imaging device 1004 according to the first embodiment includes the plurality of reference signal switches 16 corresponding to the plurality of column readout sections 17. The plurality of reference signal switches 16 is switched on or off by the column control section 15. By turning on the plurality of reference signal switches 16, the reference signal is input to the corresponding column readout section 17. Two or more reference signal switches 16 are not simultaneously turned on. The column control section 15 sequentially turns on the plurality of reference signal switches 16 and sequentially inputs the reference signals to the plurality of column readout sections 17. As a result, the load on a reference signal line Sramp that transmits the reference signal is reduced, and the AD conversion processing can be sped up and the frame rate can be increased.

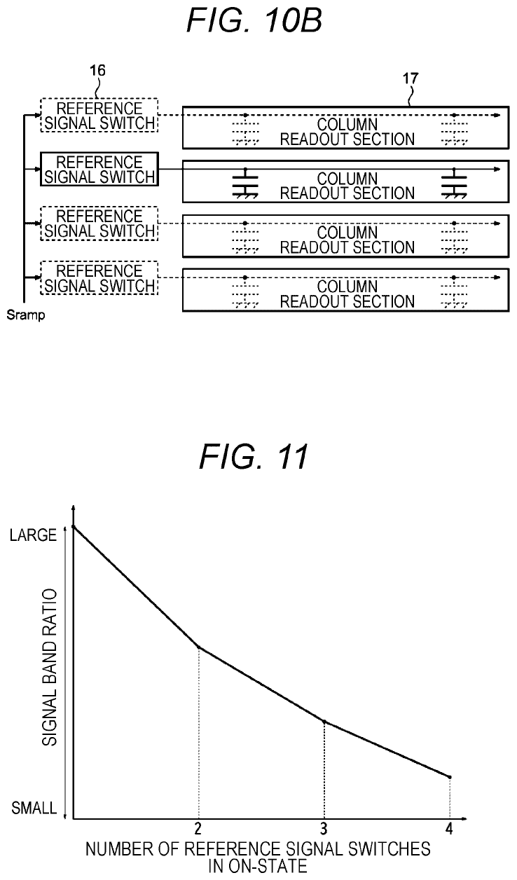

FIGS. 10A and 10B illustrate an example in which four column readout sections 17 and four reference signal switches 16 are provided corresponding to four divided signal lines obtained by dividing the vertical signal line VSL into four. FIG. 10A illustrates an example in which the uppermost reference signal switch 16 among the four reference signal switches 16 is turned on, and FIG. 10B illustrates an example in which the second reference signal switch 16 from the top among the four reference signal switches 16 is turned on. When the reference signal switch 16 is turned on, the reference signal is input to the corresponding column readout section 17, and AD conversion is performed.

The column control section 15 sequentially turns on the four reference signal switches 16 while the imaging device 1004 according to the first embodiment generates a captured image for one frame.

As described above, in the first embodiment, two or more reference signal switches 16 among the plurality of reference signal switches 16 are not simultaneously turned on to reduce the load on the reference signal line Sramp.

FIG. 11 is a graph illustrating a relationship between the number of the reference signal switches 16 that are simultaneously turned on and the load of the reference signal line Sramp. In FIG. 11, the horizontal axis represents the number of the reference signal switches that are simultaneously turned on, and the vertical axis represents the signal band ratio. A smaller signal band ratio indicates a larger load. As illustrated in FIG. 11, as the number of the reference signal switches 16 that are simultaneously turned on increases, the signal band ratio decreases and the load on the reference signal line Sramp increases.

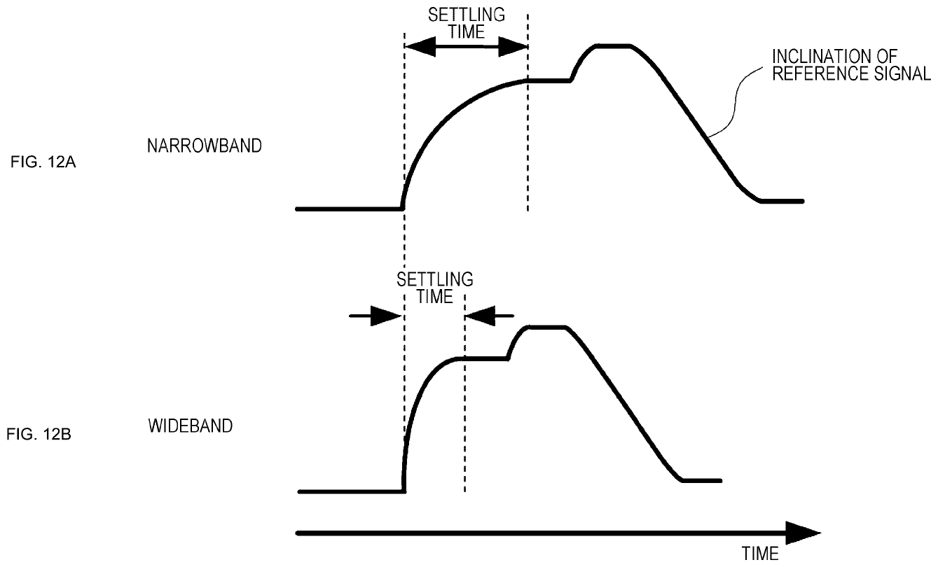

FIG. 12 is a graph illustrating a relationship between a settling time and a signal band of the reference signal RAMP on the reference signal line Sramp. FIG. 12A illustrates a graph in a case where there is only one reference signal switch 16 that is simultaneously turned on, and FIG. 12B illustrates a graph in a case where two or more reference signal switches 16 are simultaneously turned on. In FIGS. 12A and 12B, the horizontal axis represents time, and the vertical axis represents a signal level.

As can be seen from FIGS. 12A and 12B, in a case where two or more reference signal switches 16 are simultaneously turned on, the load on the reference signal line Sramp increases, the settling time increases, and the signal band narrows.

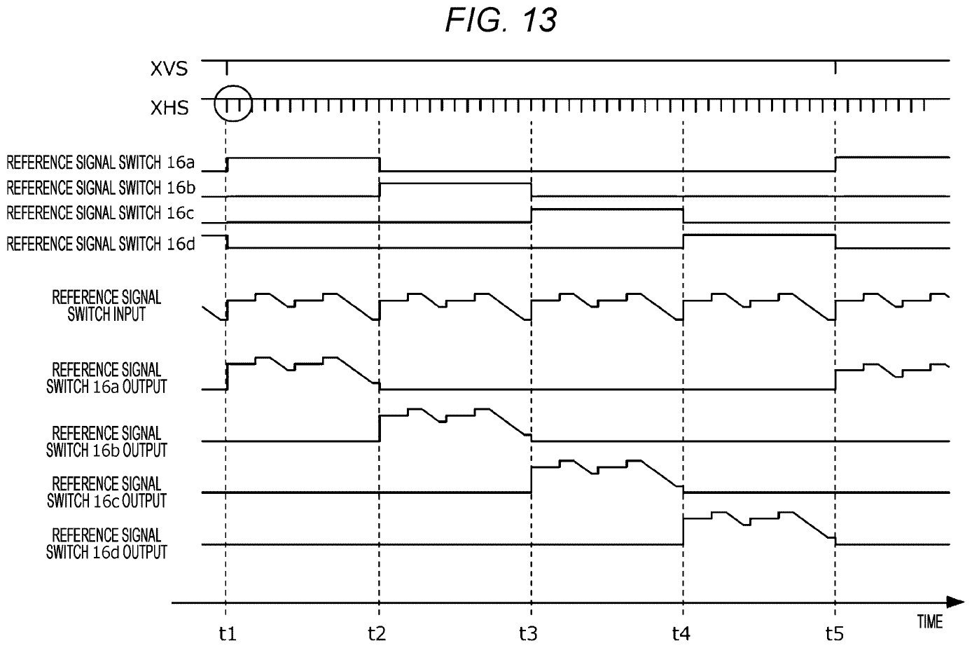

FIG. 13 is a timing diagram of the imaging device 1004 according to the first embodiment. FIG. 13 illustrates waveforms of a vertical synchronization signal XVS, a horizontal synchronization signal XHS, a plurality of switching control signals output from the column control section 15, a reference signal output from the DAC 14 and input to the plurality of reference signal switches 16, and the output signals of the plurality of reference signal switches 16. In the present specification, the plurality of reference signal switches 16 is referred to as reference signal switches 16a, 16b, 16c, and 16d. In FIG. 13, time t1 to t5 are one frame period, and the vertical synchronization signal XVS is output at the times t1 and t5.

The column control section 15 shifts each of the phases of the four switching control signals for turning on or off the four reference signal switches 16a to 16d. When each switching control signal is at a high level, the corresponding reference signal switch 16 is turned on. By shifting each of the phases of the four phase control signals, the reference signals are sequentially input to the four column readout sections 17 during one frame period. As a result, the reference signal is input to the different column readout sections 17 at the time t1 to t2, the time t2 to t3, the time t3 to t4, and the time t4 to t5, and the AD conversion processing of the pixel signal is performed in the respective column readout sections 17.

As described above, in the present embodiment, instead of simultaneously inputting the reference signals to the four column readout sections 17 by one reference signal line Sramp, the four reference signal switches 16a to 16d are turned on one by one at shifted times, and the reference signals are input to the four column readout sections 17 at shifted times. Therefore, the load of the input node of each column readout section 17 can be reduced, the AD conversion can be sped up, and the frame rate can be increased.

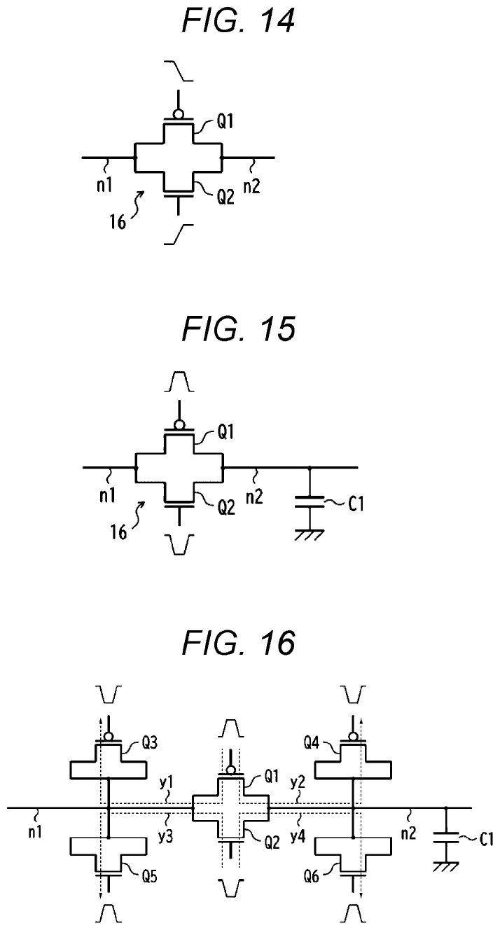

FIG. 14 is a circuit diagram illustrating a first example of the reference signal switch 16. The reference signal switch 16 according to the first example includes a PMOS transistor Q1 connected between a first node n1 and a second node n2, and an NMOS transistor Q2 also connected between the first node n1 and the second node n2. Switching control signals Φ1 and Φ2 having a logic opposite to each other are input to the gate of the PMOS transistor Q1 and the gate of the NMOS transistor Q2.

As described above, by connecting the PMOS transistor and the NMOS transistor in parallel between the first node n1 and the second node n2, it is possible to output the reference signal input to the first node n1 from the second node n2 without attenuating the signal level of the reference signal.

FIG. 15 is a circuit diagram illustrating a second example of the reference signal switch 16. The reference signal switch 16 according to the second example includes a capacitor C1 connected between the second node n2 and a reference voltage node (for example, the ground node) in addition to the circuit configuration of the first example. The capacitor C1 functions as a hold capacitor, and can hold the reference signal for a long period of time even if the switching control signal outputs a pulse for a short time and the reference signal switch 16 is turned on for a short time.

FIG. 16 is a circuit diagram illustrating a third example of the reference signal switch 16. The reference signal switch 16 according to the third example has a circuit configuration that takes measures against the injection current. The injection current is an electric charge flowing into the signal wiring from the gate at the time of switching the switch, and becomes a factor of varying the voltage level of the signal wiring. The reference signal switch 16 according to the third example includes the PMOS transistor Q1 and the NMOS transistor Q2 connected in parallel between the first node n1 and the second node n2, PMOS transistors Q3 and Q4, NMOS transistors Q5 and Q6, and the capacitor C1. The source and the drain of the transistor Q3 are connected to the first node n1. The source and the drain of the transistor Q4 are connected to the second node n2. An inversion switching control signal having a logic opposite to that of the switching control signal input to the gate of the transistor Q1 is input to the gates of the transistors Q3 and Q4. The source and the drain of the transistor Q5 are connected to the first node n1. The source and the drain of the transistor Q6 are connected to the second node n2. A switching control signal having the same logic as that of the switching control signal input to the gate of the transistor Q1 is input to the gates of the transistors Q5 and Q6.

By reversing the logic of the switching control signal applied to the gates of the transistors Q1 and Q3, the injection current can be released from the gate of the transistor Q1 to the gate of the transistor Q3 as indicated by an arrow line y1. Similarly, by reversing the logic of the switching control signal applied to the gates of the transistors Q1 and Q4, the injection current can be released from the gate of the transistor Q1 to the gate of the transistor Q3 as indicated by an arrow line y2. Similarly, by reversing the logic of the switching control signal applied to the gates of the transistors Q2 and Q5, the injection current can be released from the gate of the transistor Q2 to the gate of the transistor Q5 as indicated by an arrow line y3. Similarly, by reversing the logic of the switching control signal applied to the gates of the transistors Q2 and Q6, the injection current can be released from the gate of the transistor Q2 to the gate of the transistor Q6 as indicated by an arrow line y4.

As described above, the reference signal switch 16 according to the third example illustrated in FIG. 16 can release the injection current by reversing the logic of the switching control signal input to the gate of the transistor Q1 and the gates of the transistors Q3 and Q4 and reversing the logic of the switching control signal input to the gate of the transistor Q2 and the gates of the transistors Q5 and Q6, and can reduce the fluctuation in the voltage level of the second node n2.

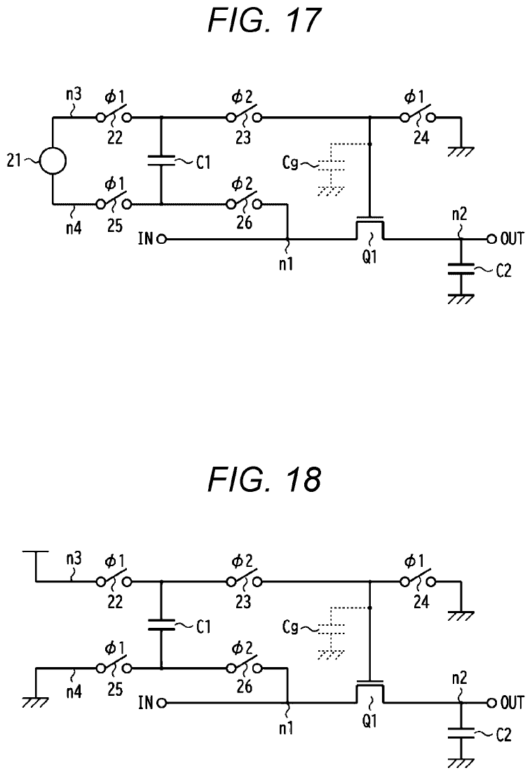

FIG. 17 is a circuit diagram illustrating a fourth example of the reference signal switch 16. The reference signal switch 16 according to the fourth example has a circuit configuration that keeps the voltage between the gate and the source of the main switch constant. As illustrated in FIG. 17, the reference signal switch 16 according to the fourth example includes: an NMOS transistor Q1 that is a main switch connected between the first node n1 and the second node n2; a voltage source 21 that outputs a bias voltage between the third node n3 and the fourth node n4; a first switch 22, a second switch 23, and a third switch 24 that are connected in series between the third node n3 and a reference voltage (for example, the ground voltage) node; a fourth switch 25 and a fifth switch 26 that are connected in series between the fourth node n4 and the first node n1; and a first capacitor C1 that is connected between a connection node of the first switch 22 and the second switch 23 and a connection node of the fourth switch 25 and the fifth switch 26, a second capacitor C2 connected between the second node n2 and a reference voltage (for example, the ground voltage) node.

The switching control signal output from the connection node of the second switch 23 and the third switch 24 is input to the gate of the transistor Q1. When the first node n1 and the second node n2 are brought into conduction, the first switch 22, the third switch 24, and the fourth switch 25 are cut off, and the second switch 23 and the fifth switch 26 are conducted. When the first node n1 and the second node n2 are cut off, the first switch 22, the third switch 24, and the fourth switch 25 are conducted, and the second switch 23 and the fifth switch 26 are cut off.

Electric charges corresponding to a bias voltage Vb are accumulated in the first capacitor C1. A gate-source voltage Vgs of the transistor Q1, which is the main switch, has a fixed value expressed by using the bias voltage Vb, a capacitance Cb of the first capacitor C1, and a gate capacitance Cg of the transistor Q1 as expressed by the following Expression (1).

$$Vgs = ( Cb \times Vb ) / Cg \qquad ( 1 )$$

The column control section 15 outputs a switching control signal φ1 for switching and controlling the first switch 22, the third switch 24, and the fourth switch 25, and a switching control signal φ2 for switching and controlling the second switch 23 and the fifth switch 26. The switching control signals φ1 and φ2 have a logic opposite to each other.

When the switching control signal φ1 is at a high level and the switching control signal φ2 is at a low level, the first switch 22, the third switch 24, and the fourth switch 25 are conducted, and the second switch 23 and the fifth switch 26 are cut off. At this time, the first capacitor C1 performs a sampling operation of accumulating electric charges according to the bias voltage Vb. Furthermore, the transistor Q1 is turned off.

When the switching control signal φ1 is at a low level and the switching control signal φ2 is at a high level, the first switch 22, the third switch 24, and the fourth switch 25 are cut off, and the second switch 23 and the fifth switch 26 are conducted. At this time, the first capacitor C1 holds the accumulated electric charge, and the transistor Q1 is turned on.

In the reference signal switch 16 according to the fourth example, since the gate-source voltage Vgs of the transistor Q1 becomes constant, the on-resistance of the reference signal switch 16 can be made constant. Therefore, even if the signal level of the reference signal changes, the signal quality (linearity or the like) of the second node n2, which is the output node of the reference signal switch 16, can be maintained.

Furthermore, by maintaining the gate-source voltage Vgs of the transistor Q1 as the main switch at a high voltage, the on-resistance can be reduced, and the signal quality such as the signal band and noise can be improved. Normally, it is necessary to increase the aspect ratio of the main switch in order to improve the signal quality, and the areas of the transistor Q1 and the first capacitor C1 can be reduced.

Note that, when the voltage level of the bias voltage Vb is increased, it is necessary to consider the breakdown voltage margin of the gate of the transistor Q1.

FIG. 18 is a circuit diagram illustrating a fifth example of the reference signal switch 16. As illustrated in FIG. 18, the reference signal switch 16 according to the fifth example includes an NMOS transistor Q1 that is a main switch connected between the first node n1 and the second node n2, the first switch 22, the second switch 23, and the third switch 24 connected in series between a first reference voltage (for example, the power supply voltage) node and a second reference voltage (for example, the ground voltage) node, the fourth switch 25 and the fifth switch 26 connected in series between the second reference voltage (for example, the ground voltage) node and the first node n1, a first capacitor C1 connected between a connection node of the fourth switch 25 and the fifth switch 26, and a second capacitor C2 connected between the second node n2 and the reference voltage (for example, the ground voltage) node.

The first switch 22, the second switch 23, the third switch 24, the fourth switch 25, and the fifth switch 26 in the reference signal switch 16 according to the fifth example are switch-controlled by the switching control signals φ1 and φ2, similarly to the first switch 22 to the fifth switch 26 in the reference signal switch 16 according to the fourth example.

The reference signal switch 16 according to the fifth example is characterized in that the voltage source 21 of the reference signal switch 16 according to the fourth example is omitted and the bias voltage Vb is set to a difference voltage between the power supply voltage VDD and the ground voltage VSS.

As described above, the imaging device 1004 according to the first embodiment sequentially shifts the timing of turning on the plurality of reference signal switches 16 so that the reference signals are input to the plurality of column readout sections 17 one by one with time shifted. As a result, the load on the reference signal line Sramp can be reduced, the AD conversion can be sped up and the frame rate can be increased in each column readout section 17, and the power consumption can be reduced.

### Second Embodiment

In the first embodiment, any one of the plurality of reference signal switches 16 is sequentially turned on, and the reference signal RAMP is sequentially input to the corresponding column readout section 17. However, a configuration is also conceivable in which a preamplifier is arranged in the preceding stage of each column readout section 17 to improve the drive capability of the reference signal.

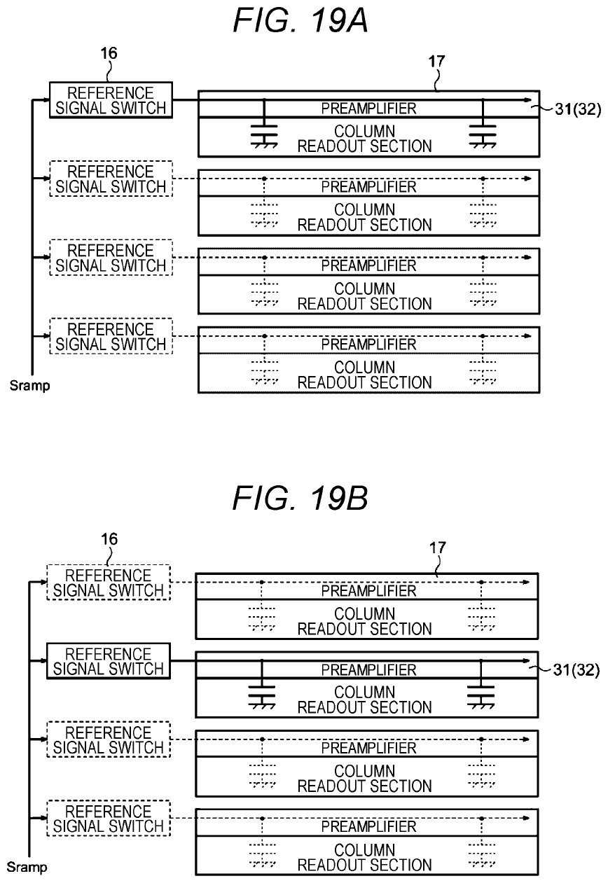

FIGS. 19A and 19B are block diagrams around the column readout section 17 of the imaging device 1004 according to the second embodiment. The imaging device 1004 according to the second embodiment includes a preamplifier 31 arranged in the preceding stage of each of the plurality of column readout sections 17. The configuration is similar to that in FIGS. 10A and 10B except that the preamplifier 31 is arranged in the preceding stage of each column readout section 17.

FIG. 19A illustrates an example in which the uppermost reference signal switch 16 among the four reference signal switches 16 is turned on, and the reference signal RAMP is input to the column readout section 17 via the uppermost preamplifier 31. FIG. 19B illustrates an example in which the second reference signal switch 16 from the top among the four reference signal switches 16 is turned on, and the reference signal RAMP is input to the column readout section 17 via the second preamplifier 31 from the top.

The preamplifier 31 includes a source follower circuit 32. The preamplifier 31 can perform impedance conversion of the reference signal by the source follower circuit 32, lower the output impedance, and output the reference signal RAMP that faithfully changes by following changes in the signal level of the input reference signal RAMP.

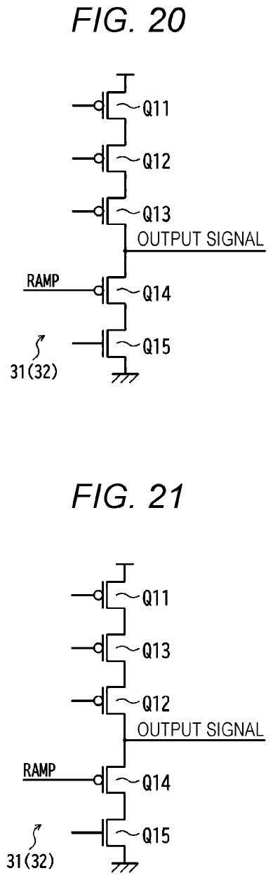

FIG. 20 is a circuit diagram illustrating a first example of the internal configuration of the preamplifier 31. The preamplifier 31 according to the first example is the source follower circuit 32 including a current source transistor Q11 connected in series between the first reference voltage (for example, the power supply voltage) node and the second reference voltage (for example, the ground voltage) node, a first current cut transistor Q12, a cascode transistor Q13, an input transistor Q14, and a second current cut transistor Q15. Only the second current cut transistor Q15 in the source follower circuit 32 is an NMOS transistor, and the other transistors are PMOS transistors.

The current source transistor Q11 functions as a current source, and a predetermined voltage is input to the gate thereof. The first current cut transistor Q12 and the second current cut transistor Q15 are for preventing a current from flowing between the source and the drain of the input transistor Q14 when the input transistor Q14 is turned on. The reference signal RAMP is input to the gate of the input transistor Q14.

The source of the input transistor Q14 and the drain of the cascode transistor Q13 are connected to the output node of the preamplifier 31. The impedance-converted reference signal RAMP is output from the output node of the preamplifier 31. The reference signal RAMP output from the output node of the preamplifier 31 is input to the corresponding column readout section 17, and AD conversion processing is performed.

The first current cut transistor Q12 and the second current cut transistor Q15 in the source follower circuit 32 connected to the preceding stage of the column readout section 17 to which the reference signal RAMP is not input are set to an off-state. As a result, the input node of the corresponding column readout section 17 can be set to high impedance, an unnecessary current does not flow in the source follower circuit 32, and power consumption can be reduced. On the other hand, the first current cut transistor Q12 and the second current cut transistor Q15 in the source follower circuit 32 connected to the preceding stage of the column readout section 17 to which the reference signal RAMP is input are set to an on-state. As a result, the reference signal RAMP having a low output impedance is output from the output node of the source follower circuit 32, and is input to the corresponding column readout section 17.

Various modifications are conceivable for the internal configuration of the source follower circuit 32 constituting the preamplifier 31. FIG. 21 is a circuit diagram illustrating a second example of the internal configuration of the preamplifier 31. The preamplifier 31 according to the second example is obtained by reversing the connection order of the first current cut transistor Q12 and the cascode transistor Q13 in the preamplifier 31 according to the first example, and the other circuit configurations are the same.

In FIG. 21, when the first current cut transistor Q12 is turned off, the drain side of the first current cut transistor Q12 becomes high impedance, and thus, the circuit operation is the same as that in a case where the cascode transistor Q13 is turned off, so that the connection order of the first current cut transistor Q12 and the cascode transistor Q13 can be reversed.

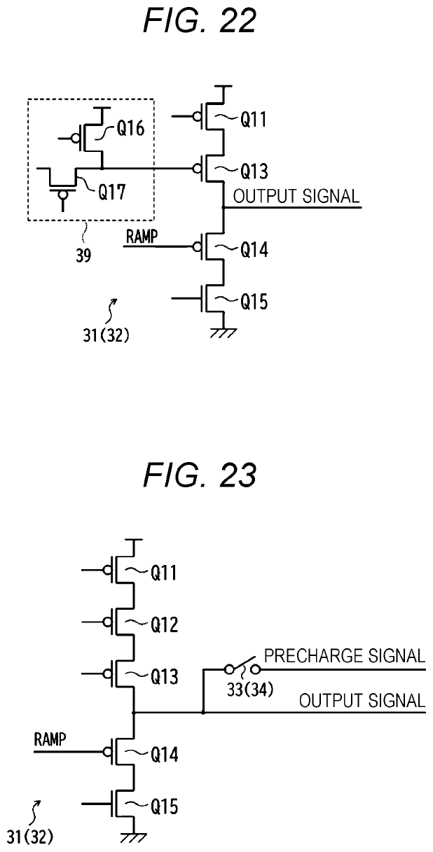

FIG. 22 is a circuit diagram illustrating a third example of the internal configuration of the preamplifier 31. In the preamplifier 31 according to the third example, the first current cut transistor Q12 in FIG. 20 is omitted, and a current cut switch 39 having the same function as the first current cut transistor Q12 is connected to the gate. As a result, the cascode transistor Q13 substantially also serves as the first current cut transistor Q12. The current cut switch 39 includes a PMOS transistor Q16 connected between the gate of the cascode transistor Q13 and the first reference voltage (for example, the power supply voltage) node, and a PMOS transistor Q17 connected between the gate of the cascode transistor Q13 and the second reference voltage (for example, the ground voltage) node.

Switching control signals having a logic opposite to each other are input to the gate of the PMOS transistor Q16 and the gate of the PMOS transistor Q17. When the PMOS transistor Q16 is turned on, the PMOS transistor Q17 is turned off, and the cascode transistor Q13 is turned off. When the PMOS transistor Q16 is turned off, the PMOS transistor Q17 is turned on, and the cascode transistor Q13 is turned on. In this manner, by using the current cut switch 39, the cascode transistor Q13 can be reliably turned off.

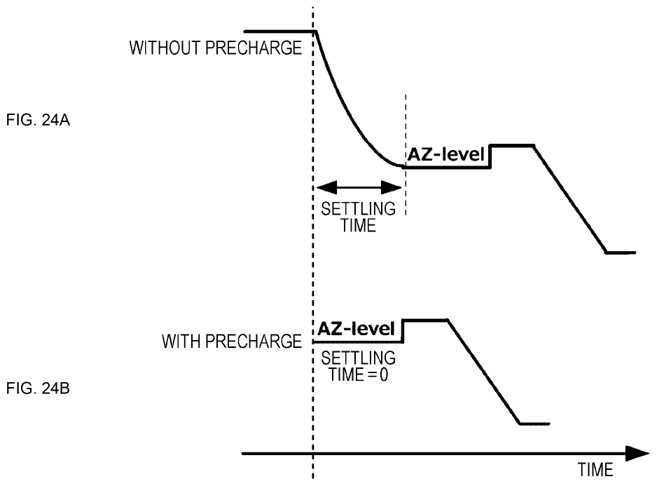

FIG. 23 is a circuit diagram illustrating a fourth example of the internal configuration of the preamplifier 31. The preamplifier 31 according to the fourth example includes a precharge circuit 33 connected to the output node of the preamplifier 31 according to any one of the first to the third examples. FIG. 23 illustrates a configuration in which the precharge circuit 33 is connected to the output node of the preamplifier 31 according to the first example, but the precharge circuit 33 may be connected to the output node of the preamplifier 31 illustrated in FIG. 21 or 22.

The precharge circuit 33 includes a precharge switch 34 connected to the output node of the preamplifier 31. The precharge switch 34 switches whether or not to supply a precharge signal to the output node of the preamplifier 31. As will be described later, the precharge signal is, for example, a signal of a reference voltage level of the reference signal RAMP.

Among the plurality of column readout sections 17, only one reference signal RAMP is input via the plurality of reference signal switches 16 and the plurality of preamplifiers 31, and the column readout section 17 to which the reference signal RAMP is input is sequentially switched. The input node of the column readout section 17 to which the reference signal RAMP is not input may have a signal level greatly different from the signal level of the reference signal RAMP, and the settling time becomes long when the reference signal RAMP is input. Therefore, by precharging the signal level of the input node of the column readout section 17 to which the reference signal RAMP is not input with the precharge signal, the settling time when the reference signal RAMP is input can be shortened.

As described above, in the second embodiment, the preamplifier 31 is arranged in the preceding stage of each column readout section 17, and the first current cut transistor Q12 and the second current cut transistor Q15 of the source follower circuit 32 in the preamplifier 31 are turned on/off in synchronization with on/off of the plurality of reference signal switches 16. As a result, in a case where the reference signal RAMP is not input to the column readout section 17, it is possible to prevent an unnecessary current from flowing in the source follower circuit 32, and it is possible to reduce power consumption.

Furthermore, by connecting the precharge circuit 33 to the output node of the preamplifier 31, the output node of the preamplifier 31 to which the reference signal RAMP is not input can be precharged, and when the reference signal RAMP is input thereafter, the output node of the preamplifier 31 can be quickly set to a desired voltage level, and the settling time can be shortened.

### Third Embodiment

The third embodiment relates to a circuit that generates a precharge signal for precharging the output node of the source follower circuit 32 in the preamplifier 31 in the second embodiment.

FIG. 24 is a graph illustrating settling time of a reference signal input to the column readout section 17 in a case where the output node of the source follower circuit 32 is precharged and in a case where the output node is not precharged. In FIG. 24, the horizontal axis represents time, and the vertical axis represents the voltage level of the input node of the column readout section 17. The upper waveform indicates the voltage waveform of the input node of the column readout section 17 in a case where the output node of the source follower circuit 32 is not precharged, and the lower waveform indicates the voltage waveform of the input node of the column readout section 17 in a case where the output node of the source follower circuit 32 is precharged.

As can be seen by comparing the two waveforms in FIG. 24, the settling time is longer in a case where the output node of the source follower circuit 32 is not precharged than in a case where the output node is precharged. In the example of FIG. 24, the settling time is shortened to almost zero by precharging the output node of the source follower circuit 32. The AZ level is a reference level of the comparator 20 in the column readout section 17.

As described in the second embodiment, when the first current cut transistor Q12 and the second current cut transistor Q15 in the source follower circuit 32 are turned off, the output node of the source follower circuit 32 is in the high impedance state, and the voltage level becomes unstable. Therefore, as illustrated in FIG. 23, when the first current cut transistor Q12 and the second current cut transistor Q15 are turned off, it is desirable to precharge the output node of the source follower circuit 32 with a precharge signal. The voltage level of the precharge signal may be the same level as the power supply voltage or the ground voltage, and the circuit that inputs the precharge signal may be a simple circuit such as a pull-up resistor or a pull-down resistor. However, if the voltage level of the precharge signal is not appropriate, the settling time at the time of inputting the reference signal becomes long, and the AD time in the column readout section 17 becomes long.

The third embodiment is characterized in that the output node of the source follower circuit 32 is precharged to the reference voltage level (AZ level) of the reference signal RAMP used when the AD conversion is performed by the column readout section 17, so that the settling time when the reference signal RAMP is input to the column readout section 17 is shortened.

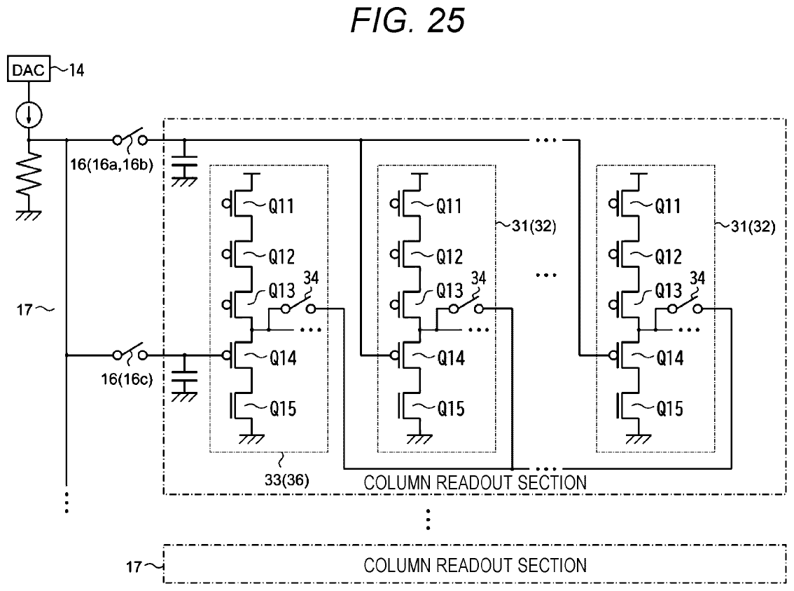

FIG. 25 is a circuit diagram around the column readout section 17 of the imaging device 1004 according to the third embodiment. The imaging device 1004 according to the third embodiment includes a plurality of reference signal switches 16, a plurality of preamplifiers 31, a plurality of column readout sections 17, and the precharge circuit 33.

The precharge circuit 33 includes a replica circuit 36 having substantially the same circuit configuration as the source follower circuit 32 in the preamplifier 31. The replica circuit 36 includes, for example, the current source transistor Q11, the first current cut transistor Q12, the cascode transistor Q13, the input transistor Q14, and the second current cut transistor Q15.

The plurality of reference signal switches 16 has, for example, the circuit configuration of any of FIGS. 14 to 18. The plurality of reference signal switches 16 is provided corresponding to the plurality of preamplifiers 31. Furthermore, a reference signal switch 16 for the precharge circuit 33 is newly provided.

The replica circuit 36 constituting the precharge circuit 33 outputs a signal of a reference voltage level of the reference signal. A plurality of precharge switches 34 is connected between the output node of the replica circuit 36 and the output nodes of the plurality of source follower circuits 32 in the plurality of preamplifiers 31. Among the plurality of precharge switches 34, the precharge switches 34 connected to the output nodes of the source follower circuits 32 on the preceding stage side of all the column readout sections 17 other than the column readout section 17 to which the reference signal is input are turned on, and the output nodes of the source follower circuits 32 are precharged. On the other hand, the precharge switch 34 connected to the output node of the source follower circuit 32 on the preceding stage side of the column readout section 17 to which the reference signal is input is turned off, and the reference signal RAMP output from the source follower circuit 32 is input to the column readout section 17.

In the present embodiment, in order to simplify the description, the imaging device 1004 including two reference signal switches 16 (16a, 16b) (hereinafter, a first reference signal switch 16a and a second reference signal switch 16b), a reference signal switch 16 (hereinafter, a third reference signal switch 16c) for the replica circuit 36, two source follower circuits 32 (a first source follower circuit 32a and a second source follower circuit 32b), and two column readout sections 17 (a first column readout section 17 and a second column readout section 17) will be described. In the present specification, the first source follower circuit 32a may be abbreviated as SF1, and the second source follower circuit 32b may be abbreviated as SF2.

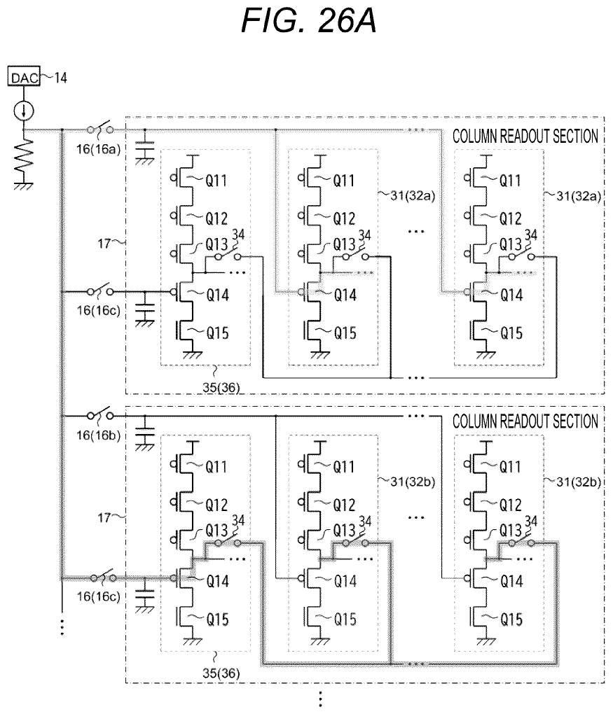

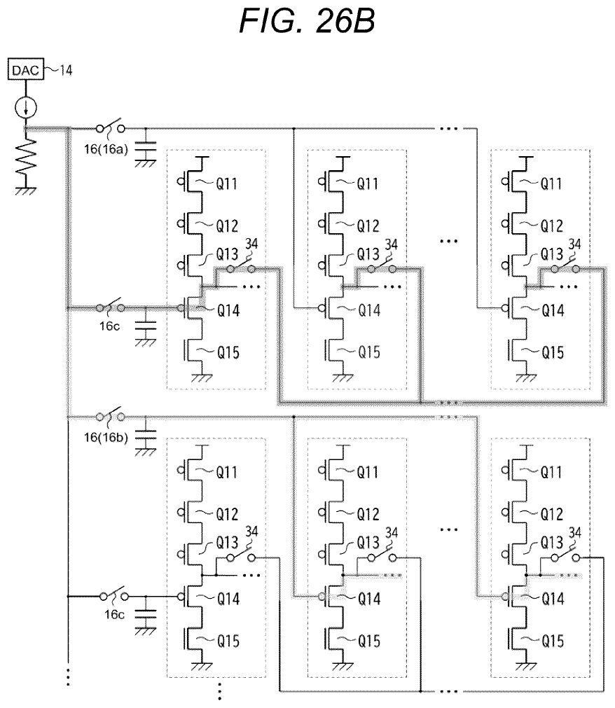

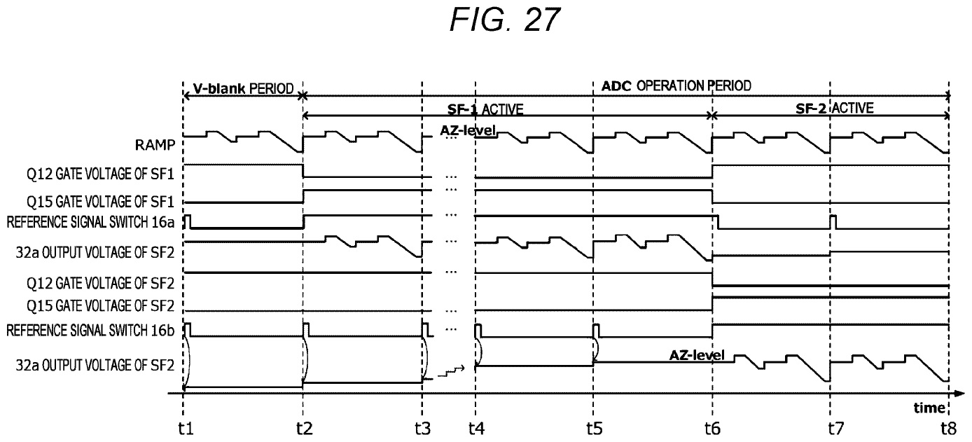

FIGS. 26A and 26B are diagrams for explaining a precharge operation of the imaging device 1004 according to the third embodiment, and FIG. 27 is a timing diagram corresponding to the explanation of FIGS. 26A and 26B. FIG. 27 illustrates waveforms of the reference signal RAMP, the gate voltage of the first current cut transistor Q12 in the first source follower circuit 32a, the gate voltage of the second current cut transistor Q15 in the first source follower circuit 32a, the switching control signal of the first reference signal switch 16a, the output voltage of the first source follower circuit 32a, the gate voltage of the first current cut transistor Q12 in the second source follower circuit 32b, the gate voltage of the second current cut transistor Q15 in the second source follower circuit 32b, the switching control signal of the second reference signal switch 16b, and the output voltage of the second source follower circuit 32b.

FIG. 26A illustrates the precharge operation when the first reference signal switch 16a is turned on and the second reference signal switch 16b is turned off. FIG. 26B illustrates the precharge operation when the first reference signal switch 16a is turned off and the second reference signal switch 16b is turned on.

Time t1 to t2 in FIG. 27 is a vertical blanking (V-blank) period. During the vertical blanking period, the first reference signal switch 16a and the third reference signal switch 16c are temporarily turned on. As a result, the first reference signal switch 16a and the third reference signal switch 16c each sample and hold the reference signal RAMP.

During a period from time t2 to t6, the first reference signal switch 16a is turned on, and the reference signal RAMP that has passed through the first reference signal switch 16a is input to the first source follower circuit 32a. In this period, the second reference signal switch 16b is turned off. Furthermore, at each of the times t2, t3, t4, and t5, the third reference signal switch 16c is temporarily turned on, and the third reference signal switch 16c samples and holds the reference signal RAMP. As a result, the voltage level of the output node of the replica circuit 36 increases stepwise. The output node of the replica circuit 36 is connected to the output node of the second source follower circuit 32b via the precharge switch 34. Since the precharge switch 34 is in an on-state, as illustrated in FIG. 26A, the output node of the second source follower circuit 32b is precharged to the same voltage level as the output node of the replica circuit 36.

Therefore, when the first current cut transistor Q12 and the second current cut transistor Q15 in the second source follower circuit 32b are turned on at the time t6, as illustrated in FIG. 26B, the second source follower circuit 32b can start outputting the reference signal RAMP having substantially the same voltage level as that before the time t6.

As described above, in the third embodiment, the replica circuit 36 having the same circuit configuration as the source follower circuit 32 is provided, and the output nodes of all the source follower circuits 32 connected to the column readout section 17 to which the reference signal RAMP is not input are precharged, so that the settling time of the input node of the column readout section 17 can be shortened when the reference signal is input.

### Fourth Embodiment

In the first to third embodiments, the example has been described in which the column readout section 17 is provided for each divided signal line obtained by dividing the vertical signal line VSL into a plurality of vertical signal lines, but the present invention is also applicable to a configuration in which a plurality of column readout sections 17 is provided without dividing the vertical signal line VSL into a plurality of vertical signal lines. Hereinafter, the imaging device 1004 in which two column readout sections 17 are provided without dividing the vertical signal line VSL into a plurality of vertical signal lines will be described.

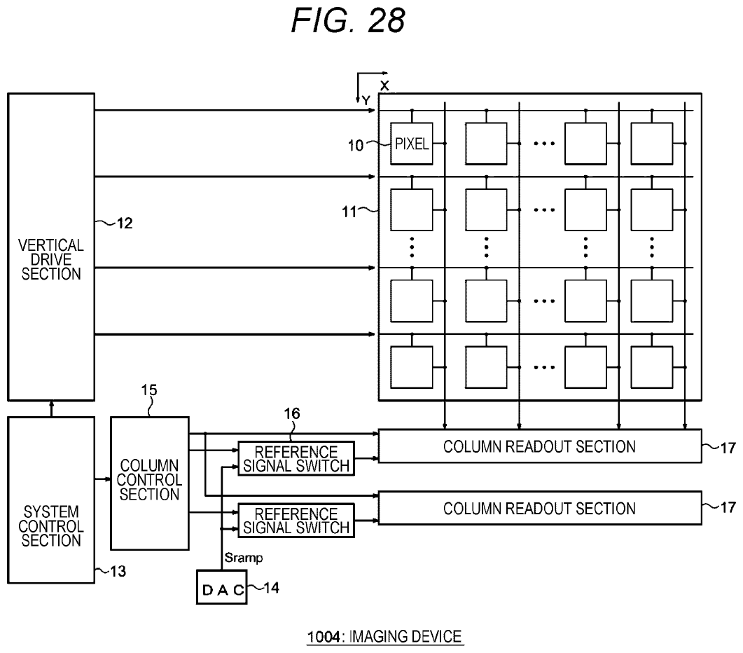

FIG. 28 is a block diagram of the imaging device 1004 according to a fourth embodiment. As illustrated in FIG. 28, the imaging device 1004 according to the fourth embodiment includes the vertical drive section 12, the system control section 13, the DAC 14, the column control section 15, the two reference signal switches 16 (16a, 16b), the pixel array section 11, and the two column readout sections 17. Note that, in FIG. 28, the column signal processing section 18 and the horizontal drive section 19 are omitted.

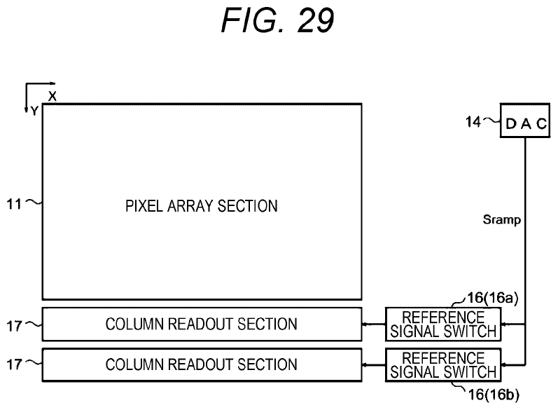

FIG. 29 is a diagram illustrating an example of arrangement places of the two column readout sections 17 in FIG. 28. As illustrated in FIG. 29, the two column readout sections 17 are arranged close to the vicinity of the lower end portion in the second direction (vertical direction) Y. The two reference signal switches 16 (16a, 16b) are arranged between the two column readout sections 17 and the DAC 14.

The two column readout sections 17 may be arranged to be spaced apart from each other on the upper end side and the lower end side in the second direction (vertical direction) Y.

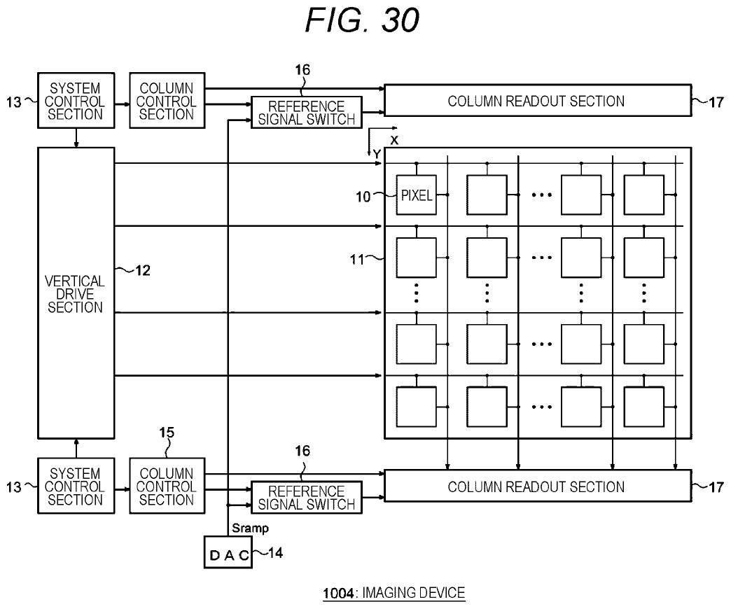

FIG. 30 is a block diagram of the imaging device 1004 according to a modification of the fourth embodiment. In FIG. 30, as compared with FIG. 29, the column control section 15 is divided into two and arranged on the upper end side and the lower end side, and the two reference signal switches 16 (16a, 16b) and the two column readout sections 17 are arranged beside these column control sections 15. In FIG. 30, the two system control sections 13 are provided in association with the two column control sections 15, but one system control section 13 may control the two column control sections 15.

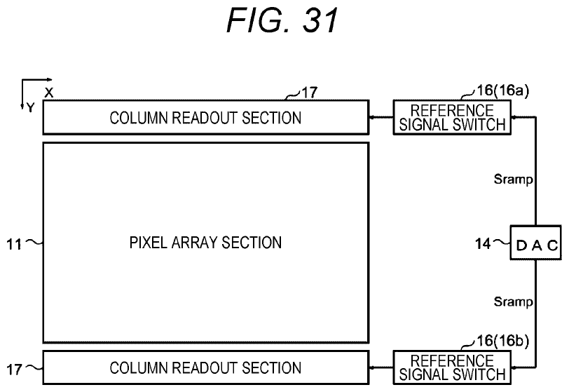

FIG. 31 is a diagram illustrating arrangement places of the two column readout sections 17 in FIG. 30. The DAC 14 is arranged in the vicinity of the central portion in the second direction (vertical direction) Y of the pixel array section 11, the two reference signal switches 16 (16a, 16b) are arranged at positions substantially equidistant from the DAC 14, and the two column readout sections 17 are arranged at positions substantially equidistant from the respective two reference signal switches 16 (16a, 16b). As a result, the propagation delay and the wiring load of the reference signal line Sramp are made equal.

Hereinafter, the two reference signal switches 16 (16a, 16b) illustrated in FIGS. 28 and 30 are referred to as a first reference signal switch 16a and a second reference signal switch 16b, and the two column readout sections 17 are referred to as a first column readout section 17 and a second column readout section 17.

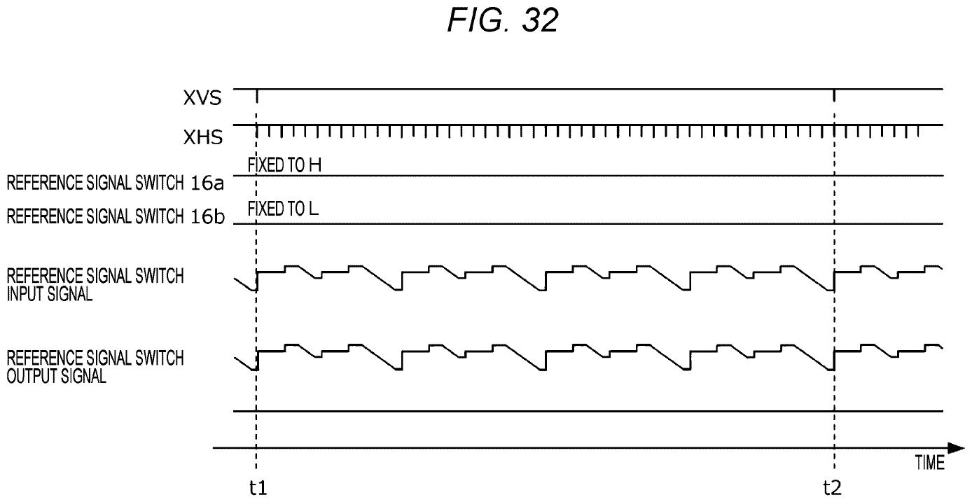

FIG. 32 is a timing diagram of the imaging device 1004 according to the fourth embodiment. FIG. 32 illustrates timing in a case where the reference signal input to one of the two column readout sections 17 is switched in units of frames. FIG. 32 illustrates each waveform of the vertical synchronization signal XVS, the horizontal synchronization signal XHS, a switching control signal of the first reference signal switch 16a, a switching control signal of the second reference signal switch 16b, the reference signals input to the first and second reference signal switches 16b, the output signal of the first reference signal switch 16a, and the output signal of the second reference signal switch 16b.

During one frame period from time t1 to t2, the first reference signal switch 16a is turned on, and the second reference signal switch 16b is turned off. Therefore, the reference signal is output from the first reference signal switch 16a and input to the first column readout section 17. The output of the second reference signal switch 16b remains at the low level, and the reference signal is not input to the second column readout section 17.

FIG. 32 illustrates an example in which the reference signal input to one of the two column readout sections 17 is switched for each frame, but the reference signal input to the two column readout sections 17 may be switched within the scanning period of each horizontal line.

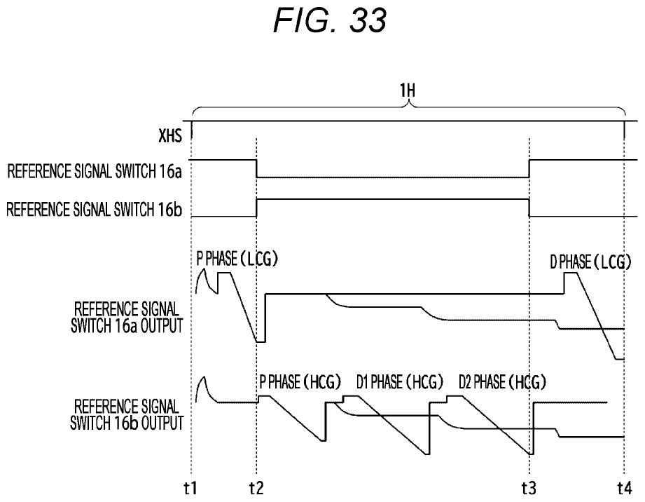

FIG. 33 is a timing diagram of the imaging device 1004 according to a modification of the fourth embodiment. FIG. 33 illustrates each waveform of the horizontal synchronization signal XHS, the switching control signal of the first reference signal switch 16a, the switching control signal of the second reference signal switch 16b, the output signal of the first reference signal switch 16a, and the output signal of the second reference signal switch 16b.

The first reference signal switch 16a is turned on and the second reference signal switch 16b is turned off at time t1 to t2 and time t3 to t4, and the first reference signal switch 16a is turned off and the second reference signal switch 16b is turned on at time t2 to t3.

A reference signal for low conversion efficiency is generated at the time t1 to t2 and at the time t3 to t4, and a reference signal for high conversion efficiency is generated at the time t2 to t3. Furthermore, AD conversion of a reset level is performed at the time t1 to t2, and AD conversion of a pixel signal level is performed at the time t3 to t4. At the time t1 to t2, the AD conversion of the reset level and the pixel signal level is continuously performed.

As described above, in the fourth embodiment, even in a case where the plurality of column readout sections 17 is provided without dividing the vertical signal line VSL, the load of the reference signal line Sramp can be reduced by sequentially supplying the reference signal to any one of the column readout sections 17 by the plurality of reference signal switches 16, and the AD time can be shortened and the frame rate can be increased.

### Fifth Embodiment

In a fifth embodiment, the imaging device 1004 according to the present disclosure is applied to a pixel ADC or an area ADC.

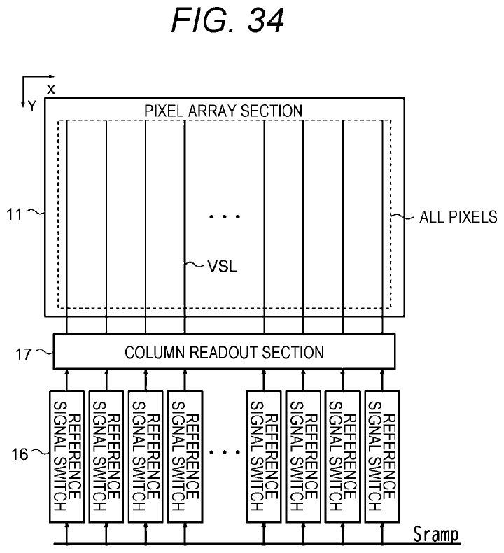

FIG. 34 is a diagram for explaining the imaging device 1004 according to the fifth embodiment. The imaging device 1004 in FIG. 34 includes an AD converter for each pixel, and the reference signal line Sramp for transmitting the reference signal RAMP used in the AD converter of each pixel is provided for each pixel column.

The plurality of reference signal lines Sramp is arranged in the first direction (horizontal direction) X, and the plurality of reference signal switches 16 are connected to the plurality of reference signal lines Sramp. Any one of the plurality of reference signal switches 16 is turned on, and the reference signal RAMP output from the turned on reference signal switch 16 is input to each AD converter of a respective one of the pixels of the corresponding pixel column.

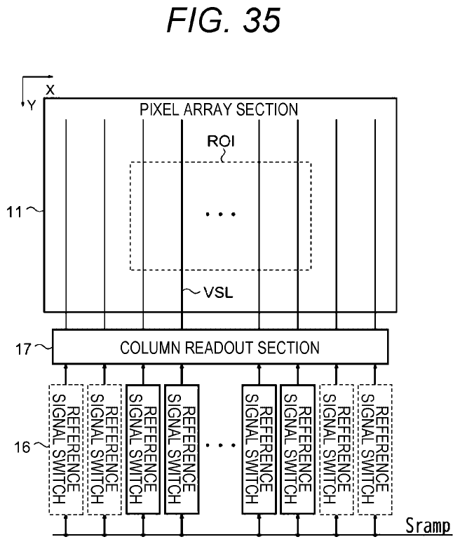

FIG. 35 is a diagram for explaining the imaging device 1004 according to a modification of the fifth embodiment. The imaging device 1004 illustrated in FIG. 35 includes an AD converter for each pixel, but can image only a pixel region of an optional size as a region of interest (ROI).

In FIG. 35, only the reference signal switch 16 connected to the pixel column corresponding to the pixel region of the ROI is sequentially turned on, and the reference signal switch 16 connected to the pixel column corresponding to the pixel region other than the pixel region of the ROI is turned off. As a result, the AD conversion time can be sped up and the frame rate can be increased.

As described above, in the fifth embodiment, in a case where the AD converter is provided for each pixel and the reference signal line Sramp is provided for each pixel column, the plurality of reference signal switches 16 is connected to the plurality of reference signal lines Sramp, any one of the plurality of reference signal switches 16 is sequentially turned on, and the reference signal is supplied to only any one of the reference signal lines Sramp. Therefore, the load of the reference signal line Sramp can be reduced, and the AD conversion can be sped up and the frame rate can be increased. Furthermore, even in a case where only the pixel region of the ROI is imaged, any one of the plurality of reference signal lines Sramp corresponding to the pixel region of the ROI is sequentially selected and the reference signal is supplied, so that the AD conversion can be further sped up and the frame rate can be further increased.

### Sixth Embodiment

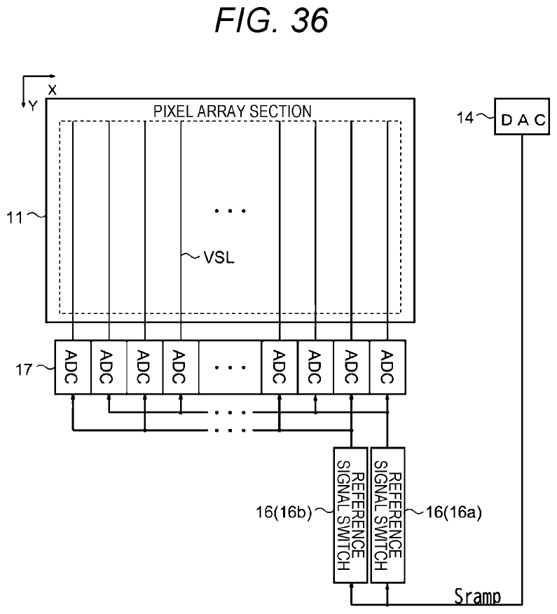

FIG. 36 is a diagram for explaining the imaging device 1004 according to a sixth embodiment. The imaging device 1004 according to the sixth embodiment is what is called a column ADC, and is provided with a column readout section 17 that performs AD conversion for each vertical signal line VSL extending in the second direction (vertical direction) Y. The plurality of vertical signal lines VSL arranged in the first direction (horizontal direction) X is connected to the column readout section 17. The column readout section 17 includes a plurality of AD converters that performs AD conversion of the pixel signals transmitted through the vertical signal lines VSL. That is, the column readout section 17 includes the same number of AD converters as the number of the vertical signal lines VSL.

In the present embodiment, among the plurality of vertical signal lines VSL, the first reference signal switch 16a that switches whether or not to input a reference signal to the AD converter to which the pixel signal from the odd-numbered vertical signal line VSL is input, and the second reference signal switch 16b that switches whether or not to input a reference signal to the AD converter to which the pixel signal from the even-numbered vertical signal line VSL is input are included.

The first reference signal switch 16a and the second reference signal switch 16b are exclusively turned on/off, and when one of the switches is turned on, the other is turned off. As a result, the load on the reference signal line Sramp that transmits the reference signal generated by the DAC 14 can be reduced.

Furthermore, as an application example of the present embodiment, it is also possible to perform AD conversion by transmitting a result obtained by adding pixel signals on two adjacent vertical signal lines VSL through any one of the vertical signal lines VSL. In this case, the reference signal switch 16 for inputting a reference signal to the AD converter to which the pixel signal on the vertical signal line VSL in which the addition result is transmitted is input is turned on, and the reference signal switch 16 for inputting a reference signal to the AD converter to which the vertical signal line VSL in which the addition result is not transmitted is connected is turned off. As a result, the load on the reference signal line Sramp can be reduced.

As described above, in the sixth embodiment, the two reference signal switches 16 (the first reference signal switch 16a and the second reference signal switch 16b) are connected to the column readout section 17 including the plurality of AD converters connected to the plurality of vertical signal lines VSL, the first reference signal switch 16a switches whether or not to input the reference signal to the odd-numbered AD converter, and the second reference signal switch 16b switches whether or not to input the reference signal to the even-numbered AD converter. By turning on one of the first reference signal switch 16a and the second reference signal switch 16b and turning off the other, the load on the reference signal line Sramp can be reduced, and the AD conversion can be sped up and the frame rate can be increased.

### Seventh Embodiment

As a concept including the first to sixth embodiments described above, the imaging device 1004 according to the seventh embodiment includes a plurality of photoelectric conversion elements, a plurality of pixel circuits, a plurality of comparators, a digital signal generator, and a plurality of switches.

For example, as illustrated in FIG. 2, the plurality of photoelectric conversion elements is arranged in the first direction X and the second direction Y intersecting each other, and each of the photoelectric conversion elements accumulates an electric charge corresponding to the amount of incident light.

Each of the plurality of pixel circuits outputs a pixel signal corresponding to the electric charge accumulated in a respective one of the plurality of photoelectric conversion elements.

The plurality of comparators (comparators 20) compares each of a plurality of pixel signals output from the plurality of pixel circuits with a reference signal. The comparator is included in the column readout section 17 in FIG. 2 and the like.

The digital signal generator generates a digital signal obtained by analog-digital conversion of the plurality of pixel signals on the basis of comparison results of the plurality of comparators. The digital signal generator is, for example, the counter 30 illustrated in FIG. 6 or the like.

The plurality of switches (reference signal switches 16) switches whether or not to input the reference signal to the plurality of comparators. In the imaging device 1004 according to the first embodiment, as illustrated in FIG. 2, the plurality of switches is provided corresponding to the plurality of column readout sections 17. In the imaging device 1004 according to the fifth embodiment, as illustrated in FIG. 34, the plurality of switches is provided corresponding to the plurality of ADCs connected to the plurality of vertical signal lines VSL. The plurality of switches sequentially selects any one of the plurality of comparators and inputs the reference signal so that the reference signal is not simultaneously input to two or more comparators.

According to the seventh embodiment, since the reference signal is not simultaneously input to the plurality of comparators, the load of the reference signal line can be reduced, and the AD conversion of the ADC can be sped up and the frame rate of the ADC can be increased, the ADC including the comparator.

### <Example of Application to Mobile Body>

The technology according to the present disclosure (present technology) can be applied to various products. For example, the technology according to the present disclosure may be implemented in the form of a device to be mounted on a mobile body of any kind, such as an automobile, an electric vehicle, a hybrid electric vehicle, a motorcycle, a bicycle, a personal mobility, an airplane, a drone, a vessel, or a robot.

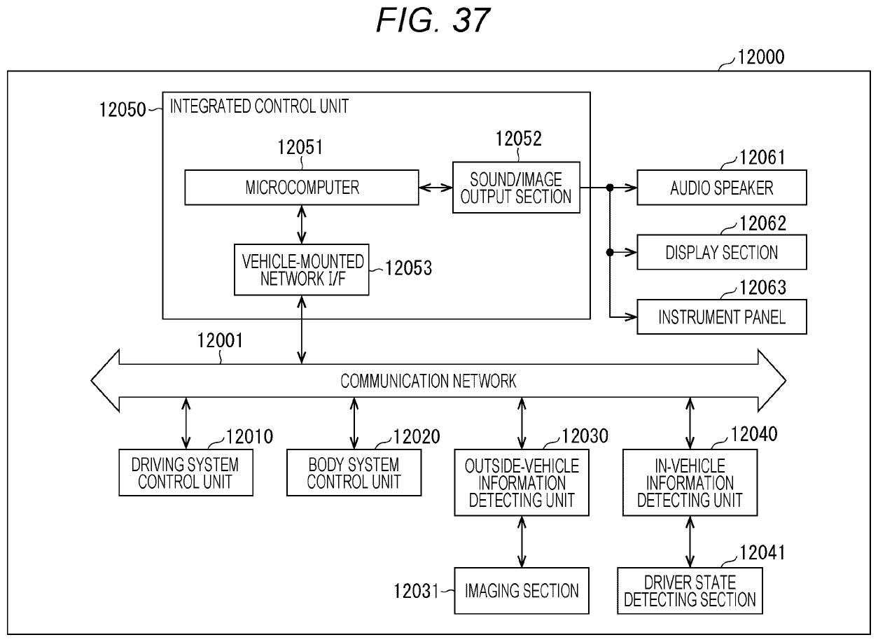

FIG. 37 is a block diagram illustrating a schematic configuration example of a vehicle control system that is an example of a mobile body control system to which the technology according to the present disclosure can be applied.

The vehicle control system 12000 includes a plurality of electronic control units connected to each other via a communication network 12001. In the example illustrated in FIG. 37, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle to travel automatedly without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

Furthermore, the microcomputer 12051 can output a control command to the body system control unit 12030 on the basis of the information about the outside of the vehicle, the information being obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 37, an audio speaker 12061, a display section 12062, and an instrument panel 12063 are illustrated as output devices. The display section 12062 may, for example, include at least one of an on-board display and a head-up display.

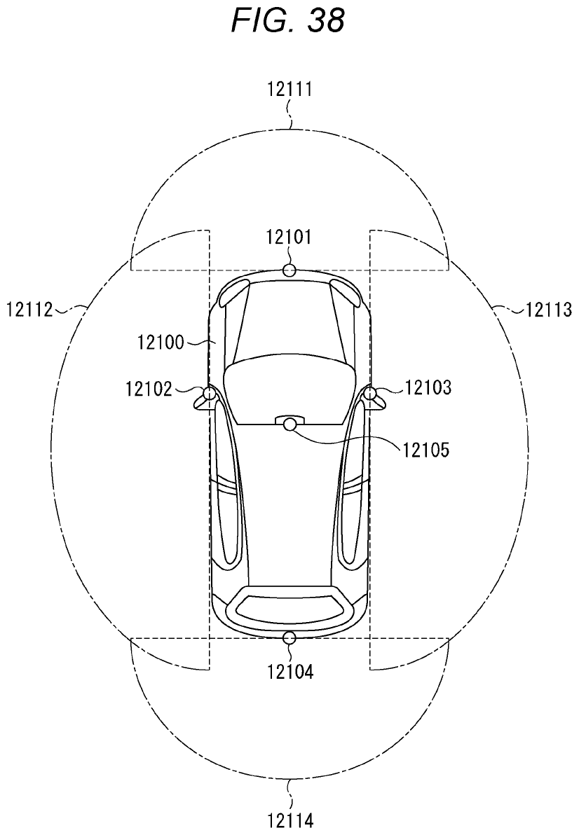

FIG. 38 is a diagram illustrating an example of an installation position of the imaging section 12031.

In FIG. 38, imaging sections 12101, 12102, 12103, 12104, and 12105 are included as the imaging section 12031.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Note that FIG. 38 illustrates an example of imaging ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to the imaging device 1004 in the configuration described above. By applying the technology according to the present disclosure, noise of the imaging device 1004 can be further reduced.

Note that the present technology may have the following configurations.
(1) An imaging device including:
a plurality of photoelectric conversion elements arranged in a first direction and a second direction intersecting each other, each of the photoelectric conversion elements accumulating an electric charge corresponding to a light amount of incident light;
a plurality of pixel circuits that outputs pixel signals corresponding to electric charges accumulated in the plurality of photoelectric conversion elements, respectively;
a plurality of comparators that compares each of the plurality of pixel signals output from the plurality of pixel circuits with a reference signal;
a digital signal generator that generates a digital signal obtained by analog-digital conversion of the plurality of pixel signals on the basis of comparison results of the plurality of comparators; and
a plurality of switches that switches whether or not to input the reference signal to the plurality of comparators.
(2) The imaging device according to (1), in which
the plurality of switches sequentially selects any one of the plurality of comparators and inputs the reference signal so that the reference signal is not simultaneously input to two or more of the comparators.
(3) The imaging device according to (1) or (2), further including:
a signal line that transmits the plurality of pixel signals output from two or more of the pixel circuits arranged in the second direction; and
a conversion circuit that performs analog-digital conversion of the plurality of pixel signals transmitted through the signal line, in which
the conversion circuit includes:
the comparator; and the digital signal generator.
(4) The imaging device according to (3), further including:
a plurality of the signal lines arranged in the first direction; and
a plurality of the conversion circuits connected to the plurality of signal lines.
(5) The imaging device according to (3) or (4), in which
the signal line includes a plurality of divided signal lines divided along the second direction,
each of the plurality of divided signal lines transmits the pixel signal output from two or more of the pixel circuits arranged along the second direction, and
each of the plurality of divided signal lines is provided with one or more of the comparators.
(6) The imaging device according to (1) or (2), in which
each of the plurality of comparators is provided for a respective one of the plurality of pixel circuits.
(7) The imaging device according to (6), in which
the plurality of switches switches whether or not to input the reference signal to the corresponding two or more comparators for each pixel group including two or more of the pixel circuits arranged in the first direction or the second direction.
(8) The imaging device according to (6), in which
the plurality of switches sequentially switches and selects, among a plurality of pixel groups each including two or more of the pixel circuits arranged in the first direction or the second direction, any one of a plurality of the pixel groups corresponding to a focused pixel region.
(9) The imaging device according to (6), in which
the plurality of switches sequentially switches and selects, among a plurality of pixel groups each including two or more of the pixel circuits arranged in the first direction or the second direction, any one of two or more pixel groups adjacent in the first direction or the second direction.

(10) The imaging device according to any one of (1) to (9), in which
the digital signal generator includes a counter that outputs, as the digital signal, a count value corresponding to a timing at which the pixel signal and the reference signal match in each of the plurality of comparators.
(11) The imaging device according to any one of (1) to (10), in which
at least one of the plurality of switches includes:
a first transistor of a first conductivity type that switches whether to conduct or cut off a first node and a second node by a switching control signal; and
a second transistor of a second conductivity type that switches whether to conduct or cut off the first node and the second node by an inversion switching control signal having a logic opposite to that of the switching control signal.
(12) The imaging device according to (11), in which
at least one of the plurality of switches includes:
a third transistor of a first conductivity type having a source and a drain connected to the first node, and a gate to which the inversion switching control signal is input;
a fourth transistor of a first conductivity type having a source and a drain connected to the second node, and a gate to which the inversion switching control signal is input;
a fifth transistor of a second conductivity type having a source and a drain connected to the first node, and a gate to which the switching control signal is input; and
a sixth transistor of a second conductivity type having a source and a drain connected to the second node, and a gate to which the switching control signal is input.
(13) The imaging device according to (11) or (12), further including
a capacitor arranged between the second node and a reference voltage node, in which
the second node is connected to input nodes of the plurality of comparators.
(14) The imaging device according to any one of (1) to (10), in which
at least one of the plurality of switches includes:
a first transistor that switches whether to conduct or cut off the first node and the second node by a switching control signal;
a voltage source that outputs a bias voltage between a third node and a fourth node;
a first switch, a second switch, and a third switch connected in series between the third node and a reference voltage node;
a fourth switch and a fifth switch connected in series between the fourth node and the first node;
a first capacitor connected between a connection node of the first switch and the second switch and a connection node of the fourth switch and the fifth switch; and
a second capacitor connected between the second node and the reference voltage node,
the switching control signal output from a connection node of the second switch and the third switch is input to a gate of the first transistor,
when the first node and the second node are brought into conduction, the first switch, the third switch, and the fourth switch are cut off, and the second switch and the fifth switch are conducted, and
when the first node and the second node are cut off, the first switch, the third switch, and the fourth switch are conducted, and the second switch and the fifth switch are cut off.
(15) The imaging device according to any one of (1) to (10), in which
at least one of the plurality of switches includes:
a first transistor that switches whether to conduct or cut off the first node and the second node by a switching control signal;
a first switch, a second switch, and a third switch connected in series between a first reference voltage node and a second reference voltage node;
a fourth switch and a fifth switch connected in series between the second reference voltage node and the first node;
a first capacitor connected between a connection node of the first switch and the second switch and a connection node of the fourth switch and the fifth switch; and
a second capacitor connected between the second node and the second reference voltage node,
the switching control signal output from a connection node of the second switch and the third switch is input to a gate of the first transistor,
when the first node and the second node are brought into conduction, the first switch, the third switch, and the fourth switch are cut off, and the second switch and the fifth switch are conducted, and
when the first node and the second node are cut off, the first switch, the third switch, and the fourth switch are conducted, and the second switch and the fifth switch are cut off.
(16) The imaging device according to any one of (1) or (15), further including
a plurality of preamplifiers arranged between the plurality of switches and the plurality of comparators and including a plurality of source follower circuits that convert impedances of the reference signals output from the plurality of switches, in which
each of the plurality of source follower circuits includes:
a first transistor having a gate to which the reference signal output from the corresponding switch is input;
a second transistor of a first conductivity type that is connected to a drain side of the first transistor and is turned on when the corresponding switch outputs the reference signal and is turned off when the corresponding switch does not output the reference signal; and
a third transistor of a second conductivity type that is connected to a source side of the first transistor and is turned on when the corresponding switch outputs the reference signal and is turned off when the corresponding switch does not output the reference signal.
(17) The imaging device according to claim 16), in which
each of the plurality of source follower circuits includes:
a fourth transistor that functions as a current source; and
a fifth transistor that adjusts a voltage of an input node of the corresponding comparator,
between a first reference voltage node and a second reference voltage node, the fourth transistor, the third transistor, the fifth transistor, the first transistor, and the second transistor are connected in this order, or the fourth transistor, the fifth transistor, the third transistor, the first transistor, and the second transistor are connected in this order.
(18) The imaging device according to any one of (1) to (15), further including
a plurality of preamplifiers arranged between the plurality of switches and the plurality of comparators and including a plurality of source follower circuits that convert impedances of the reference signals output from the plurality of switches, in which
each of the plurality of source follower circuits includes:
a first transistor having a gate to which the reference signal output from the corresponding switch is input;
a second transistor of a first conductivity type that is connected to a drain side of the first transistor and is turned on when the corresponding switch outputs the reference signal and is turned off when the corresponding switch does not output the reference signal;
a third transistor that is connected to a source side of the first transistor and functions as a current source;
a fourth transistor that adjusts a voltage of an input node of the corresponding comparator;
a fifth transistor that is connected to a gate of the fourth transistor and is turned on when the corresponding switch outputs the reference signal to turn on the fourth transistor; and
a sixth transistor that is connected to a gate of the fourth transistor and turns on when the corresponding switch does not output the reference signal to turn off the fourth transistor.
(19) The imaging device according to any one of (16) to (18), further including
a precharge circuit that supplies a precharge signal to a source of the first transistor in a source follower circuit that does not output the reference signal from a source of the first transistor among the plurality of source follower circuits.
(20) The imaging device according to (19), in which
the precharge circuit further includes a replica circuit that has the same circuit configuration as the plurality of source follower circuits and generates, as the precharge signal, a reference voltage of the reference signal when the plurality of comparators starts a comparison operation, and
the precharge circuit supplies the reference voltage generated by the replica circuit to a source of the first transistor in a source follower circuit that does not input the reference signal to the corresponding comparator among the plurality of source follower circuits.

Modes of the present disclosure are not limited to the individual embodiments described above, but include various modifications that may be conceived by those skilled in the art, and the effects of the present disclosure are not limited to the contents described above. That is, various additions, changes, and partial deletions can be made without departing from the conceptual idea and scope of the present disclosure derived from the contents specified in the claims and equivalents and the like thereof.

### REFERENCE SIGNS LIST

10 Pixel
11 Pixel array section
12 Vertical drive section
13 System control section
15 Column control section
16 Reference signal switch
16a First reference signal switch
16b Second reference signal switch
16c Third reference signal switch
17 Column readout section
18 Column signal processing section
19 Horizontal drive section
20 Comparator
21 Voltage source
22 First switch
23 Second switch
24 Third switch
25 Fourth switch
26 Fifth switch
30 Counter
31 Preamplifier
32 Source follower circuit
32a First source follower circuit
32b Second source follower circuit
33 Precharge circuit
34 Precharge switch
36 Replica circuit
39 Current cut switch
40 Logic circuit
50 Peripheral circuit
60 Interface circuit
100 Photoelectric conversion section
101 Pixel
101 Circuit section
102 Pixel
201 First-stage comparator
202 Intermediate-stage comparator
203 Post-stage comparator

1. An imaging device comprising:
a plurality of photoelectric conversion elements arranged in a first direction and a second direction intersecting each other, each of the photoelectric conversion elements accumulating an electric charge corresponding to a light amount of incident light;
a plurality of pixel circuits that outputs pixel signals corresponding to electric charges accumulated in the plurality of photoelectric conversion elements, respectively;
a plurality of comparators that compares each of the plurality of pixel signals output from the plurality of pixel circuits with a reference signal;
a digital signal generator that generates a digital signal obtained by analog-digital conversion of the plurality of pixel signals on a basis of comparison results of the plurality of comparators; and
a plurality of switches that switches whether or not to input the reference signal to the plurality of comparators.

2. The imaging device according to claim 1, wherein
the plurality of switches sequentially selects any one of the plurality of comparators and inputs the reference signal so that the reference signal is not simultaneously input to two or more of the comparators.

3. The imaging device according to claim 1, further comprising:
a signal line that transmits the plurality of pixel signals output from two or more of the pixel circuits arranged in the second direction; and
a conversion circuit that performs analog-digital conversion of the plurality of pixel signals transmitted through the signal line, wherein
the conversion circuit includes:
the comparator; and the digital signal generator.

4. The imaging device according to claim 3, further comprising:
a plurality of the signal lines arranged in the first direction; and
a plurality of the conversion circuits connected to the plurality of signal lines.

5. The imaging device according to claim 3, wherein
the signal line includes a plurality of divided signal lines divided along the second direction,
each of the plurality of divided signal lines transmits the pixel signal output from two or more of the pixel circuits arranged along the second direction, and
each of the plurality of divided signal lines is provided with one or more of the comparators.

6. The imaging device according to claim 1, wherein
each of the plurality of comparators is provided for a respective one of the plurality of pixel circuits.

7. The imaging device according to claim 6, wherein
the plurality of switches switches whether or not to input the reference signal to the corresponding two or more comparators for each pixel group including two or more of the pixel circuits arranged in the first direction or the second direction.

8. The imaging device according to claim 6, wherein
the plurality of switches sequentially switches and selects, among a plurality of pixel groups each including two or more of the pixel circuits arranged in the first direction or the second direction, any one of a plurality of the pixel groups corresponding to a focused pixel region.

9. The imaging device according to claim 6, wherein
the plurality of switches sequentially switches and selects, among a plurality of pixel groups each including two or more of the pixel circuits arranged in the first direction or the second direction, any one of two or more pixel groups adjacent in the first direction or the second direction.

10. The imaging device according to claim 1, wherein
the digital signal generator includes a counter that outputs, as the digital signal, a count value corresponding to a timing at which the pixel signal and the reference signal match in each of the plurality of comparators.

11. The imaging device according to claim 1, wherein
at least one of the plurality of switches includes:
a first transistor of a first conductivity type that switches whether to conduct or cut off a first node and a second node by a switching control signal; and
a second transistor of a second conductivity type that switches whether to conduct or cut off the first node and the second node by an inversion switching control signal having a logic opposite to that of the switching control signal.

12. The imaging device according to claim 11, wherein
at least one of the plurality of switches includes:
a third transistor of a first conductivity type having a source and a drain connected to the first node, and a gate to which the inversion switching control signal is input;
a fourth transistor of a first conductivity type having a source and a drain connected to the second node, and a gate to which the inversion switching control signal is input;
a fifth transistor of a second conductivity type having a source and a drain connected to the first node, and a gate to which the switching control signal is input; and
a sixth transistor of a second conductivity type having a source and a drain connected to the second node, and a gate to which the switching control signal is input.

13. The imaging device according to claim 11, further comprising
a capacitor arranged between the second node and a reference voltage node, wherein
the second node is connected to input nodes of the plurality of comparators.

14. The imaging device according to claim 1, wherein
at least one of the plurality of switches includes:
a first transistor that switches whether to conduct or cut off the first node and the second node by a switching control signal;
a voltage source that outputs a bias voltage between a third node and a fourth node;
a first switch, a second switch, and a third switch connected in series between the third node and a reference voltage node;
a fourth switch and a fifth switch connected in series between the fourth node and the first node;
a first capacitor connected between a connection node of the first switch and the second switch and a connection node of the fourth switch and the fifth switch; and
a second capacitor connected between the second node and the reference voltage node,
the switching control signal output from a connection node of the second switch and the third switch is input to a gate of the first transistor,
when the first node and the second node are brought into conduction, the first switch, the third switch, and the fourth switch are cut off, and the second switch and the fifth switch are conducted, and
when the first node and the second node are cut off, the first switch, the third switch, and the fourth switch are conducted, and the second switch and the fifth switch are cut off.

15. The imaging device according to claim 1, wherein
at least one of the plurality of switches includes:
a first transistor that switches whether to conduct or cut off the first node and the second node by a switching control signal;
a first switch, a second switch, and a third switch connected in series between a first reference voltage node and a second reference voltage node;
a fourth switch and a fifth switch connected in series between the second reference voltage node and the first node;
a first capacitor connected between a connection node of the first switch and the second switch and a connection node of the fourth switch and the fifth switch; and
a second capacitor connected between the second node and the second reference voltage node,
the switching control signal output from a connection node of the second switch and the third switch is input to a gate of the first transistor,
when the first node and the second node are brought into conduction, the first switch, the third switch, and the fourth switch are cut off, and the second switch and the fifth switch are conducted, and
when the first node and the second node are cut off, the first switch, the third switch, and the fourth switch are conducted, and the second switch and the fifth switch are cut off.

16. The imaging device according to claim 1, further comprising:
a plurality of preamplifiers arranged between the plurality of switches and the plurality of comparators and including a plurality of source follower circuits that convert impedances of the reference signals output from the plurality of switches, wherein
each of the plurality of source follower circuits includes:
a first transistor having a gate to which the reference signal output from the corresponding switch is input;
a second transistor of a first conductivity type that is connected to a drain side of the first transistor and is turned on when the corresponding switch outputs the reference signal and is turned off when the corresponding switch does not output the reference signal; and
a third transistor of a second conductivity type that is connected to a source side of the first transistor and is turned on when the corresponding switch outputs the reference signal and is turned off when the corresponding switch does not output the reference signal.

17. The imaging device according to claim 16, wherein
each of the plurality of source follower circuits includes:
a fourth transistor that functions as a current source; and
a fifth transistor that adjusts a voltage of an input node of the corresponding comparator,
between a first reference voltage node and a second reference voltage node, the fourth transistor, the third transistor, the fifth transistor, the first transistor, and the second transistor are connected in this order, or the fourth transistor, the fifth transistor, the third transistor, the first transistor, and the second transistor are connected in this order.

18. The imaging device according to claim 1, further comprising
a plurality of preamplifiers arranged between the plurality of switches and the plurality of comparators and including a plurality of source follower circuits that convert impedances of the reference signals output from the plurality of switches, wherein
each of the plurality of source follower circuits includes:
a first transistor having a gate to which the reference signal output from the corresponding switch is input;
a second transistor of a first conductivity type that is connected to a drain side of the first transistor and is turned on when the corresponding switch outputs the reference signal and is turned off when the corresponding switch does not output the reference signal;
a third transistor that is connected to a source side of the first transistor and functions as a current source;
a fourth transistor that adjusts a voltage of an input node of the corresponding comparator;
a fifth transistor that is connected to a gate of the fourth transistor and is turned on when the corresponding switch outputs the reference signal to turn on the fourth transistor; and
a sixth transistor that is connected to a gate of the fourth transistor and turns on when the corresponding switch does not output the reference signal to turn off the fourth transistor.

19. The imaging device according to claim 16, further comprising
a precharge circuit that supplies a precharge signal to a source of the first transistor in a source follower circuit that does not output the reference signal from a source of the first transistor among the plurality of source follower circuits.

20. The imaging device according to claim 19, wherein
the precharge circuit further includes a replica circuit that has the same circuit configuration as the plurality of source follower circuits and generates, as the precharge signal, a reference voltage of the reference signal when the plurality of comparators starts a comparison operation, and
the precharge circuit supplies the reference voltage generated by the replica circuit to a source of the first transistor in a source follower circuit that does not input the reference signal to the corresponding comparator among the plurality of source follower circuits.
